(19) United States
(12) Patent Application Publication
(10) Pub. No.: US 2026/0348522 A1
(43) Pub. Date: Nov. 5, 2026

(54) Flexible Tensegrity mechanical core

(71) Applicant: Silliam Bims, Portland, OR (US)

(72) Inventor: Silliam Bims, Portland, OR (US)

(21) Appl. No.: 19/729,093

(22) Filed: Apr. 1, 2026

Related U.S. Application Data
(60) Provisional application No. 63/782,017, filed on Apr. 2, 2025.

(51) Int. Cl. F16S 3/08; F16L 59/065; F16S 1/14; F17C 13/00; F28F 27/00; G01K 13/00; G01M 3/26; G05B 19/042; H02J 50/10

(52) U.S. Cl. CPC F16S 3/08; F16L 59/065; F16S 1/14; F17C 13/001; F28F 27/00; G01K 13/00; G01M 3/26; G05B 19/042; H02J 50/10; F17C 2203/01; F17C 2203/011; F17C 2225/0161; G05B 2219/25257

(57) ABSTRACT

A mechanical tensegrity framework comprises, in a first embodiment, discrete self-equilibrating modules assembled into columns by inter-tier tensile elements in which adjacent modules physically interpenetrate without contact, the columns laterally interconnected by spacers governing inter-column spacing and enabling controlled compound-curve flexure. In a second embodiment, modules having six compressive elements arranged as three pairs with twelve endpoints corresponding to the stellated points of the first stellation of the rhombic dodecahedron or a variant form are assembled in a packed arrangement without fixed inter-module connections, maintaining tensegrity conditions at the system level under compressive loading through inter-module contact governed by the tensile chord envelope of each module. Both embodiments produce an open-structure core with conduction pathways confined to tensile elements, enabling efficient evacuation when enclosed in a hermetic envelope. The open void volume permits dynamic pressurization—intentional cycling between vacuum and atmospheric pressure—as a controllable performance parameter. Discrete programmatic layers allow tailored structural, mechanical, electromagnetic, or acoustic characteristics across applications including flexible panels, wearable garments, aerospace components, architectural assemblies, and metamaterial configurations.

### CROSS-REFERENCE TO RELATED APPLICATIONS

This application claims the benefit of U.S. Provisional Patent Application No. 63/782,017, filed Apr. 2, 2025, the entire contents of which are incorporated herein by reference.

### BACKGROUND OF THE INVENTION

The present invention relates generally to mechanical framework technologies, and more particularly to self-equilibrating tensegrity modules and frameworks assembled therefrom, for applications requiring structural adaptability, mechanical resilience, dynamic flexure, controlled thermal performance, electromagnetic functionality, acoustic management, or any combination of these objectives across a wide range of scales and operating environments. The framework is particularly advantageous for use as a core in vacuum-insulated panels, where its open-structure geometry minimizes solid conduction pathways and resists atmospheric collapse without reliance on porous or granular fill materials; however, the inventive framework is not limited to thermal insulation applications and is equally applicable to deployable and collapsible structural systems, wearable and flexible load-bearing assemblies, architectural and aerospace components, and programmable metamaterial configurations. The thermal insulation context is used throughout this description as a primary illustrative embodiment and should not be construed as limiting the scope of the invention.

Vacuum-insulated panels are known for providing effective thermal insulation by minimizing heat transfer through conduction, convection, and radiation under evacuated conditions. Conventional VIPs typically include a microporous or open-cell core material such as fumed silica, fiberglass mats, aerogels, or open-cell polyurethane foam-encased within a hermetic envelope that is evacuated to low pressure. While effective for many uses, these designs result in rigid, flat panels whose geometry is dictated by the structural requirements of the core and envelope. Attempts to introduce flexibility have included cores formed from fiberglass mats or silica aerogels, which offer limited bendability but exhibit low-to-moderate resilience under repeated dynamic stress, and segmented rigid panels that fold along predefined seams, which suffer from thermal bridging and reduced durability at fold lines. High-performance core materials such as aerogels carry elevated material costs. All conventional VIP cores are non-mechanical: they rely on the bulk compressive properties of porous or granular fill materials to resist atmospheric collapse, and they provide no mechanism for programmable structural or functional adaptation.

The structural relationship between discontinuous compression and continuous tension—the defining principle of tensegrity as formalized by Fuller in U.S. Pat. No. 3,063,521 (1962)—has been recognized in limited prior art as conceptually relevant to vacuum-insulated panel design. Prior approaches in this space have employed planar arrays of compression elements joined by tension membranes, or wall-supported arrays of pillar supports engaged by tensile filaments spanning between opposing panel walls, to resist atmospheric collapse while minimizing conductive heat paths. These approaches represent meaningful advances over porous-fill cores in certain respects, particularly in reducing the cross-sectional area of solid conduction pathways. However, they share a fundamental architectural limitation: the compression elements in each case are structurally dependent upon the enclosing walls or spanning membranes, and cannot maintain their geometric arrangement independently. No prior design has employed a core comprised of discrete, three-dimensional, self-equilibrating tensegrity modules—structural units that maintain their own internal compressive-tensile balance independently of any enclosing wall or membrane. As a consequence, prior mechanical VIP core approaches have been inherently rigid, have exhibited limited volumetric efficiency, and have provided no mechanism for compound-curve panel flexure, scalable hierarchical structural organization, or programmatic functional adaptation across thermal and electromagnetic objectives within a single unified framework.

There exists a need for a mechanical VIP core architecture founded on discrete self-equilibrating tensegrity modules that can be organized, in one embodiment, into series columns laterally interconnected by spacers to enable controlled compound-curve flexure and programmable mechanical resilience across a range of panel scales and applications, and that can be configured, in another embodiment, as geometrically optimized modules suited to interlocking or nesting arrangements that collectively resist compressive loading without fixed inter-module connections, for manufacturable packed-core panels. In either configuration, the open internal volume inherent to genuine tensegrity module geometry maximizes the evacuable void fraction, minimizes solid conduction pathways, compounds the thermal bottleneck across successive structural tiers, and provides a substrate for programmatic layer configurations targeting diverse functional objectives that no prior VIP core design has been capable of addressing within a single structural platform.

### SUMMARY OF THE INVENTION

The present invention provides, in a first embodiment, a flexible tensegrity framework comprising a plurality of discrete self-equilibrating modules, each module comprising compressive elements isolated from direct contact and held in a stable spatial arrangement solely by intra-module tensile elements, the modules assembled end-to-end by inter-tier tensile elements into columns in which adjacent modules physically interpenetrate without contact, and the columns laterally interconnected by spacers connecting to mid-tensile elements at positions governing inter-column spacing and enabling controlled flexure of the framework. This column-and-spacer framework is particularly advantageous for use as a core in vacuum-insulated panels requiring compound-curve flexibility, programmable mechanical resilience, and adaptability across a range of scales from wearable garments to architectural components.

In a second embodiment, the present invention provides a mechanical tensegrity framework comprising a plurality of discrete modules each having six compressive elements arranged as three pairs straddling a shared central origin, with twelve endpoints collectively positioned in correspondence with the stellated points of the first stellation of the rhombic dodecahedron or a topologically similar form, the modules assembled in a packed arrangement without fixed inter-module connections such that under compressive loading the aggregate maintains tensegrity conditions at the system level through inter-module contact at surfaces governed by the tensile chord envelope of each module. This packed-core framework is particularly advantageous for large-area or irregularly shaped vacuum-insulated panels where manufacturing simplicity and bulk filling methods are priorities, and for applications where the three-dimensional engagement geometry of the module enables deliberately organized structural assemblies.

Both embodiments share the common inventive foundation of the discrete self-equilibrating tensegrity module and the thermal bottleneck principle arising from it: because compressive elements within each module do not contact one another and tensile elements may be fabricated with minimal cross-sectional area, solid conduction pathways through the framework are confined to the tensile elements themselves, and the overall thermal conductivity of the framework decreases as a function of the number of tiers and the thermal properties of the tensile elements, providing a compounding thermal resistance not available in prior VIP core designs.

The tensegrity core occupies a relatively small solid volume with minimal direct conduction paths, facilitating low overall thermal conductivity and enabling efficient evacuation when enclosed in a hermetic envelope. The open void volume of the framework further enables dynamic pressurization—intentional cycling of the panel's internal pressure between vacuum and atmospheric conditions—as a controllable thermal management parameter, a designed operational mode made possible by the framework's open geometry and having no analog in prior VIP core designs employing porous or granular fill materials.

The design enables adaptability across a wide range of scales and applications through the use of discrete programmatic layers—groupings of modules and columns sharing specific structural, mechanical, or functional characteristics tailored to the goals of a particular embodiment-including flexible panels for wearable garments and aerospace applications, larger architectural components, and precision configurations for electromagnetic and metamaterial functions. By varying component geometries, lengths, material compositions, and surface treatments across layers, embodiments may achieve harmonic resonances, attenuation, amplification, shaping, plasmonic coupling, or focusing of electromagnetic frequencies, and dynamic structural responses to environmental stresses.

### BRIEF DESCRIPTION OF THE DRAWINGS

FIG. 1A (oblique view) illustrates a single n=3 module with 30° module rotation angle, showing compressive elements (101) and all three intra-module tensile element categories—top-tensile (102), bottom-tensile (103), and mid-tensile (104)—in their respective positional roles.

FIG. 1B (top plan view) illustrates the same single n=3 module with 30° module rotation angle, showing compressive elements (101) and all three intra-module tensile element categories—top-tensile (102), bottom-tensile (103), and mid-tensile (104)—in their respective positional roles.

FIG. 2 (side elevation) illustrates a two-tier column showing the rotational offset between modules, inter-tier tensile elements (105), and interpenetrating compressive element geometry.

FIG. 3 (oblique view) illustrates the same two-tier column with foil guide (106), showing the adjusted top-tensile (102) and bottom-tensile (103) element trajectory.

FIG. 4 (top plan view) illustrates the compounding of module rotation across a multi-tier column and its effect on successive module orientation and alignment, indicating compressive (101), inter-tier tensile (105), and mid-tensile (104) elements.

FIG. 5 (top plan view) illustrates a basic grouping of three modules joined around a shared geometric center with spacers (107) via rotational compliance fittings (108) fastened along their reciprocal mid-tensile elements (104). Inter-column span (109) is indicated with a bilateral dimension line.

FIG. 6A (top plan view) illustrates open (110) spacer connection patterns as dictated by module rotation angle.

FIG. 6B (top plan view) illustrates a combination of both open (110) and closed (111) spacer connection patterns as dictated by module rotation angle.

FIG. 7 (oblique view) illustrates an eight-tier column with two spacers (107) branching from each module.

FIG. 8A (oblique view) illustrates a grouping of three modules positioned at the vertices of an equilateral triangle where inter-column span is equal to module span.

FIG. 8B (oblique view) illustrates a grouping of three modules positioned at the vertices of an equilateral triangle where inter-column span is greater than module span.

FIG. 9 (schematic plan view) illustrates a basic equilateral tiling pattern produced by repetition of a triangular three-column grouping wherein deliberate voids are introduced between column groupings at regular spatial intervals.

FIG. 10A (plan view, detail) illustrates five columns of a larger four-tier layer with alternating arrangements of open and closed spacers and with inter-column span equal in length to module span.

FIG. 10B (schematic plan view) illustrates the same four-tier layer with alternating arrangements of open and closed spacers and an inter-column span greater in length than module span with columns represented schematically as circles.

FIG. 10C (oblique view) illustrates an alternative layer of comparable size with inter-column span greater than module span and with columns represented with reduced internal components for clarity.

FIG. 11 (side elevation) illustrates the fulcrum-tier flexibility mechanism, showing three columns connected by a fulcrum spacer (112) positioned at the central tier of the layer and peripheral spacers, including a peripheral spacer stretched into an expanded state (113) and peripheral spacers compressed into a contracted state (114), with the layer in a flexed state.

FIG. 12A (oblique view) illustrates Escher's Solid positioned in a typical orthogonal orientation. Points marked with a circled dot and “x” indicate rotation of shape from 12A to 12B.

FIG. 12B (oblique view) illustrates Escher's Solid positioned in an axial orientation so that the topmost and bottommost points are positioned along a polar axis through the center of the shape. Points marked with a circled dot and “x” indicate rotation of shape from 12A to 12B.

FIG. 13A (oblique view) illustrates all 12 points of the solid as positioned in FIG. 12A indicating a single point on the relative base plane (201), four points on the relative near plane (202), two points terminating a line coincidental to the relative mid plane (203), four points on the relative far plane (204), and one point at the relative diametric plane (205), with a diametric connection from relative base plane (201) to relative diametric plane (205) rendered as a dotted line perpendicular to all planes. Points marked with a circled dot and “x” indicate rotation of shape from 13A to 13B.

FIG. 13B (oblique view) illustrates all 12 points of the solid as positioned in FIG. 12B indicating a single point on the relative base plane (201), four points on the relative near plane (202), two points terminating a line coincidental to the relative mid plane (203), four points on the relative far plane (204), and one point at the relative diametric plane (205), with a diametric connection from relative base plane (201) to relative diametric plane (205) rendered as a dotted line perpendicular to all planes. Points marked with a circled dot and “x” indicate rotation of shape from 13A to 13B.

FIG. 14A (oblique view) illustrates an orthogonal arrangement of six compressive elements arranged in three pairs each straddling the shared central origin and terminating at the 12 points of the ideal Escher's Solid as positioned in FIG. 12A and FIG. 13A. Points marked with a circled dot and “x” indicate rotation of shape from 14A to 14B.

FIG. 14B (oblique view) illustrates an orthogonal arrangement of six compressive elements arranged in three pairs straddling the shared central origin and terminating at the 12 points of the ideal Escher's Solid as positioned in FIG. 12B and FIG. 13B. Points marked with a circled dot and “x” indicate rotation of shape from 14A to 14B.

FIG. 15A (oblique view) illustrates an axial arrangement of six compressive elements grouped in three pairs which stagger the origin and terminating at the 12 points of the ideal Escher's Solid as positioned in FIG. 12A, FIG. 13A, and FIG. 14A with polar groupings of three co-planar points positioned at the vertices of a solid-line reference triangle (206), and with an equatorial grouping of six co-planar points positioned at the vertices of a solid-line reference hexagon (207). While tensile elements are omitted for clarity, the compressive element positions define the available tensile connection space.

FIG. 15B (oblique view) illustrates an axial arrangement of six compressive elements grouped in three pairs which stagger the origin and terminating at the 12 points of the ideal Escher's Solid as rotated from FIG. 15A, with polar groupings of three co-planar points positioned at the vertices of a solid-line reference triangle (206), and with an equatorial grouping of six co-planar points positioned at the vertices of a solid-line reference hexagon (207). While tensile elements are omitted for clarity, the compressive element positions define the available tensile connection space.

FIG. 16 (oblique view) illustrates a module comprised of an orthogonal arrangement of compressive pairs with each pair offset inward toward each other and the origin and with tensile elements connecting all near-plane compressive ends so as to yield four triangles whose legs constitute the outermost chords of the module. Additionally the inset orthogonal arrangement enables mid-plane connections (208) that would otherwise be obstructed by compressive elements positioned at the ideal geometry of Escher's Solid.

FIG. 17 (oblique view) illustrates a module with an orthogonal arrangement of six compressive elements each terminating at the 12 points of the ideal Escher's Solid, with 3 tensile elements connected from each of the 12 ends of the compressive elements to connection locations (209) at the midpoints of compressive elements coinciding with the near plane and mid plane relative to the originating point, producing a tensegrity-contour analog to the first stellation of the rhombic dodecahedron.

FIG. 18 (oblique view) illustrates an orthogonal arrangement of three pairs of compressive elements whose length and distance from each other define the vertices of three golden rectangles and whose terminals collectively define the points of an icosahedron.

FIG. 19A (oblique view) illustrates the inset orthogonal variant of the unified solid Escher module, comprising three planar rectangular blocks joined at a shared central origin, with the blocks' straight edges offset inward from the ideal Escher's Solid geometry toward the origin, and with tensile elements connecting each of the twelve endpoints to four near-rank connections and one mid-rank connection, yielding five tensile connections per endpoint.

FIG. 19B (oblique view) illustrates the same inset orthogonal unified solid module as FIG. 19A, rotated to present a direct view into one of the module's eight trihedral corner reflector geometries (210) formed at the vertices of the orthogonal arrangement, showing the three mutually perpendicular reflective faces meeting at the vertex.

FIG. 20A (oblique view) illustrates the axial arrangement of the unified solid Escher module with reflective surface treatment, showing the asymmetric non-orthogonal trihedral corner reflector geometries (211) of the equatorial face groupings and the alternating orientation of the preferred retroreflective axes of adjacent equatorial units around the equatorial ring. Tensile elements are omitted for clarity. The polar axis is indicated as a dotted reference line (212).

FIG. 20B (trimetric view) illustrates the same axial unified solid module as FIG. 20A, oriented with the polar axis normal to the viewing plane to present a direct view of the symmetric non-orthogonal trihedral corner reflector geometry (213) at the pole. Tensile elements are omitted for clarity.

FIG. 21A (oblique view) illustrates a fully scalloped orthogonal variant of the unified solid Escher module, comprising three planar rectangular blocks joined at a shared central origin with endpoints at the ideal Escher's Solid geometry, each block presenting concave scalloped profiles along all edges to clear tensile connection paths, and with near-rank tensile connections present at all twelve endpoints.

FIG. 21B (trimetric view) illustrates the same scalloped orthogonal unified solid module as FIG. 21A, oriented to present a direct view into one of the module's eight trihedral corner reflector geometries (210), showing the three mutually perpendicular reflective faces meeting at the vertex.

FIG. 22 (schematic view) illustrates the three-axis geometry of the Anomalous Nernst Effect, showing a representative material block with Hot and Cold indicated at opposing ends of the heat flow axis, magnetic field axis oriented perpendicular to the heat flow axis, and electric field axis oriented perpendicular to both, with the governing cross-product relationship V∝∇T×M.

FIG. 23 (cross-section) illustrates a vacuum membrane assembly comprising a hermetic membrane layer (214) organized into a continuously curved surface geometry supported against atmospheric load by a semi-rigid manifold underlayment (215) and overlayment (216), showing the pre-formed surface geometry of the membrane in a neutral state.

FIG. 24 (oblique view) illustrates a Miura-fold surface geometry accommodating flexure into a compound irregular curve through the folding and unfolding of pre-formed fold geometry rather than elastic stretching of the membrane material.

FIG. 25 (cross-section) illustrates a Miura-fold variant of the vacuum membrane assembly comprising a manifold overlayment (216), vacuum membrane (217) pre-cast into Miura-fold geometry in an unfolded and unstressed neutral state with reinforced cast profile thickness at fold ridges (218) and manifold underlayment (215).

### DETAILED DESCRIPTION OF THE INVENTION

### Nomenclature and General Framework Introduction

In accordance with the present invention, a mechanical tensegrity framework is provided comprising discrete, self-equilibrating modules assembled into a lightweight, open-structure core capable of controlled flexure, dynamic stress distribution, resilience under compressive load, and tunable mechanical properties across thermal, electromagnetic, and acoustic performance objectives. The framework is particularly advantageous for use as a core in vacuum-insulated panels, where it enables high thermal performance while resisting vacuum collapse without reliance on porous or granular fill materials, though numerous other applications are contemplated, including flexible lightweight mats, deployable structures, acoustic attenuation panels, and programmable metamaterial systems. For the purposes of this description, the following nomenclature is adopted.

The term “module” denotes the smallest fundamental and self-contained structural unit of the framework, comprising a discrete grouping of compressive elements held in a stable spatial arrangement solely by mechanical connections to tensile elements, such that the compressive elements do not directly contact one another. The term “compressive element” refers to any rigid or semi-rigid structural member—such as a strut, rod, bar, or multi-branched rigid unit—that carries compressive load within a module. The term “tensile element” refers to any member—such as a cable, wire, filament, cord, or thin rod—having high tensile strength relative to its cross-sectional area, used to maintain the spatial arrangement of compressive elements within or between modules. Within the column-and-spacer embodiment described herein, tensile elements within a given module are further classified by their positional role: “mid-tensile elements” connect upper attachment points of compressive elements with lower attachment points of adjacent compressive elements and govern the module's lateral geometry; “top-tensile elements” connect attachment points at or near the upper ends of compressive elements and define the module's upper planar boundary; and “bottom-tensile elements” connect attachment points at or near the lower ends of compressive elements and define the module's lower planar boundary. “Inter-tier tensile elements” are tensile elements external to any individual module that connect the ends of compressive elements in one module to the ends of compressive elements in an adjacent module within a column, governing inter-module positioning without intra-module involvement.

The term “column” refers to a linear series of modules assembled end-to-end along a common directional axis by inter-tier tensile elements. The term “tier” denotes all modules sharing the same depth position across multiple columns within a layer. The term “inter-tier offset” refers to the variable overlap between adjacent modules within a column, governed by the length and mechanical properties of the inter-tier tensile elements. The term “spacer” refers to structural components extending laterally between adjacent columns, mechanically connecting to reciprocal mid-tensile elements within those columns at positions governing inter-column spacing; spacers may perform compressive, tensile, or combined functions depending on the embodiment. The term ‘inter-column span’ refers to the lateral distance between adjacent columns as measured between the nearest points in the circles containing the compressive endpoints of the same tier, a measurement that may be taken at any tier but most naturally reflects the spacing between column footings. The term “column grouping” refers to a repeating pattern of columns and their associated spacers that may be tiled to produce a layer of desired lateral dimensions. The term “layer” refers to a discrete programmatic grouping of modules, columns, spacers, and associated components sharing specific structural, mechanical, or functional characteristics tailored to the objectives of a particular embodiment; multiple layers may be combined, scaled, or fractally compounded within a single panel. The term “membrane” refers to any film or composite sheet incorporated within or between layers to impart targeted properties, including thermal reflection, electromagnetic interaction, mechanical reinforcement, or hermetic sealing.

The term ‘axial arrangement’ refers to a configuration of the six compressive elements of a packed-core module in which the three compressive pairs are grouped into two hemispheres, each hemisphere containing one member of each of the three compressive pairs, such that all six compressive elements have one endpoint terminating in a common equatorial ring and one endpoint terminating in a polar circle, both the equatorial ring and the polar circle being radially symmetric around a common polar axis. The axial arrangement is distinguished from the orthogonal arrangement by this hemispheric grouping and polar-equatorial endpoint distribution, and produces a module geometry with three-fold rotational symmetry about the polar axis. The terms ‘orthogonal’ and ‘axial’ are used throughout this description to distinguish these two primary categorical arrangements of the six compressive elements onto the twelve endpoint positions of the module geometry.”

### Shared Module Self-Equilibration Principle

The discrete self-equilibrating tensegrity module serves as the fundamental building block shared across all embodiments of the present invention. Each module is a self-contained structural unit in which a plurality of compressive elements are held in a stable spatial arrangement solely by mechanical connections to intervening tensile elements, without direct contact between any two compressive elements within the module. This internal compressive-tensile balance is genuine at the unit level: each module maintains its own geometric equilibrium independently of any enclosing wall, membrane, or neighboring module. As a consequence, incidental failure or instability in one module propagates minimally—if at all—to adjacent modules. Because compressive elements within any module do not contact one another and tensile elements may be fabricated with minimal cross-sectional area, solid conduction pathways through any given module are confined to the tensile elements themselves. When modules are assembled into columns and layers, the thermal conduction path between opposing faces of the framework must traverse successive tensile bottlenecks—one at each tier—rather than passing through a continuous solid medium, providing a compounding thermal resistance whose magnitude decreases as a function of the number of tiers, the cross-sectional area and thermal conductivity of the tensile elements, and the geometric efficiency of the module arrangement.

This modular independence enables two structurally distinct embodiments of the present invention. In the preferred column-and-spacer embodiment, modules are assembled into oriented columns and laterally interconnected by spacers to produce a hierarchically organized framework capable of controlled compound-curve flexure and programmable mechanical resilience, as described in paragraphs [0012] through [0017]. In the alternative packed-core embodiment, modules of a geometry specifically suited to interlocking or nesting arrangements that collectively resist compressive loading without fixed inter-module connections are assembled into a core whose mechanical and thermal performance emerges from the collective geometric interaction of the individual modules, as described in paragraphs [0018] through [0020].

### Column-and-Spacer Embodiment: Module Geometry and Intra-Module Tensile Classification

In the preferred column-and-spacer embodiment, the fundamental module comprises a plurality of compressive elements—such as struts, rods, or rigid bars—arranged with radial symmetry around a common central axis, each element tilted in a consistent clockwise or counterclockwise rotational direction relative to that axis, such that no two compressive elements converge to a point of contact at the axis or at any other point. The number of compressive elements per module, designated n, is typically between 3 and 7, with n=3 representing the simplest and most open configuration. Each compressive element is positioned at a base angle of 360°/n from its neighbors as measured around the central axis, and is tilted so that its upper and lower ends are similarly offset by the same base angle. The rotational offset of the upper ends of the compressive elements relative to the lower ends—referred to herein as the module rotation angle—must be greater than 0° and less than 60° for an n=3 module to achieve structural self-sufficiency, with a practical working range of approximately 15° to 45°. At 0° rotation the module has poor structural integrity; as rotation approaches 60° the compressive elements converge toward the central axis and risk contact. The diameter of the compressive elements further constrains the practical upper limit of the rotation angle for a given module span. The module's overall dimensions are characterized by two primary parameters: the module height, defined as the distance between the upper and lower planar boundaries of the module, and the module span, defined as the length of any single top-tensile or bottom-tensile element.

Within each module, tensile elements are classified into three categories according to their positional role and the geometric boundary they define.

Top-tensile elements connect the upper attachment points of adjacent compressive elements to one another, tracing the upper planar boundary of the module. For an n=3 module there are three top-tensile elements, each spanning between the upper ends of two adjacent compressive elements. Together they define the module's upper plane and, in a column assembly, harmonize in orientation with the bottom-tensile elements of the module in the adjacent tier above, a relationship whose significance for membrane coordination across a layer is described below.

Bottom-tensile elements connect the lower attachment points of adjacent compressive elements to one another, tracing the lower planar boundary of the module. Their configuration mirrors that of the top-tensile elements at the module's lower plane.

Mid-tensile elements connect upper attachment points of compressive elements with lower attachment points of adjacent compressive elements providing essential tensile resistance to lateral deformation. The midpoints of the mid-tensile elements correspond to the mid-plane of the module's height and may serve as the attachment locations for spacers in the column grouping assembly described below, making the mid-tensile element the primary structural interface between a module's internal geometry and the inter-column lateral network.

The length, pre-tension, and material properties of all three tensile element categories are selected in combination to define the module's overall geometry, stiffness, and thermal performance. Because tensile elements may be fabricated with minimal cross-sectional area relative to their tensile strength, their contribution to solid conduction pathways through the module is minimized, and the module's overall open volume—the evacuable void fraction—is maximized. The selection of tensile element material accordingly involves balancing tensile strength, thermal conductivity, and, where relevant, electromagnetic or acoustic properties appropriate to the programmatic objectives of the layer in which the module is employed.

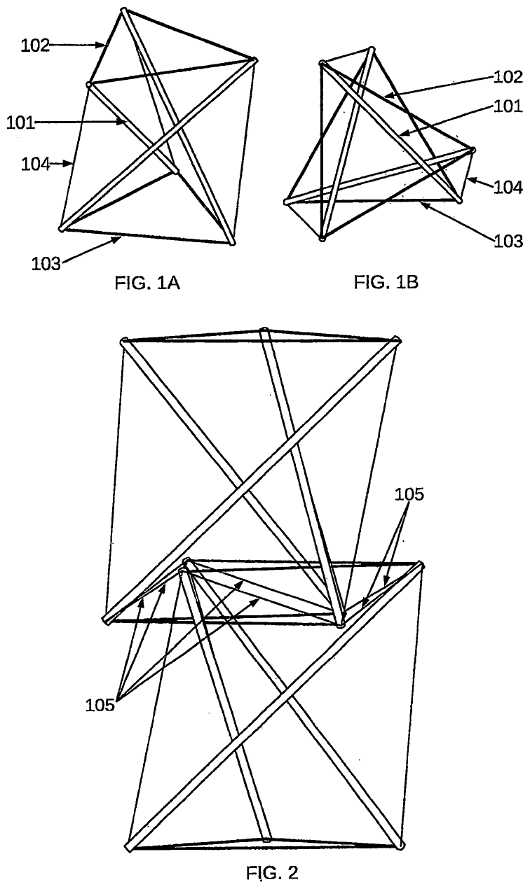

The top-tensile, bottom-tensile, and mid-tensile elements together constitute the complete set of tensile elements internal to any individual module. In the column-and-spacer embodiment, no tensile element internal to a module participates in positioning that module relative to any neighboring module within a column or column grouping. The positional relationship between adjacent modules within a column is governed exclusively by a fourth category of tensile element—the inter-tier tensile element—which is external to both modules it connects and is described in the column assembly section that follows. This categorical distinction between intra-module and inter-tier tensile elements is maintained throughout the present description and is reflected in the mechanical connection hierarchy described below. [FIG. 1A]

### Column Assembly, Interpenetration, Inter-Tier Tensile Elements, and Foil Guide

When modules are assembled into columns, successive modules are oriented along a shared directional axis with each module rotationally offset from its neighbor so that the upper ends of the compressive elements in the lower module are positioned evenly between the lower ends of the compressive elements in the module above. This rotational offset ensures that the compressive elements of adjacent modules are angularly interleaved rather than aligned, which is a prerequisite for the interpenetrating column geometry described below.

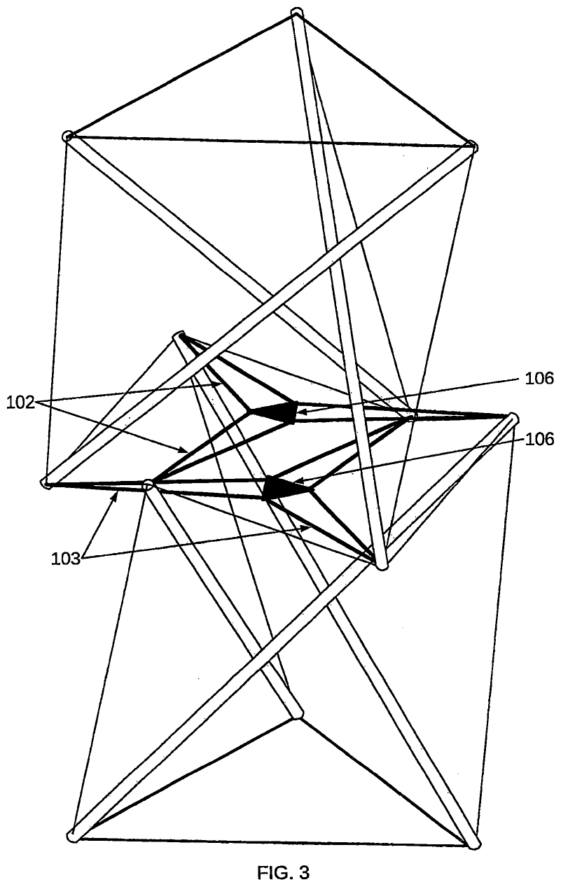

Adjacent modules within a column are connected solely by inter-tier tensile elements. Each inter-tier tensile element connects the upper end of a compressive element in the lower module directly to the lower end of a compressive element in the module above, applying pre-tension across the inter-tier overlap that maintains the precise spatial separation between modules. The length and mechanical properties of the inter-tier tensile elements govern the inter-tier overlap: the distance over which the compressive elements of adjacent modules physically interpenetrate. As a consequence of the rotational offset and governed spatial separation, the compressive elements of one module pass through the open spatial intervals between the compressive elements of the adjacent module without any direct physical contact—a structural relationship that eliminates direct compressive thermal bridging between modules along the column axis and contributes to the compounding of the thermal bottleneck across successive tiers. [FIG. 2]

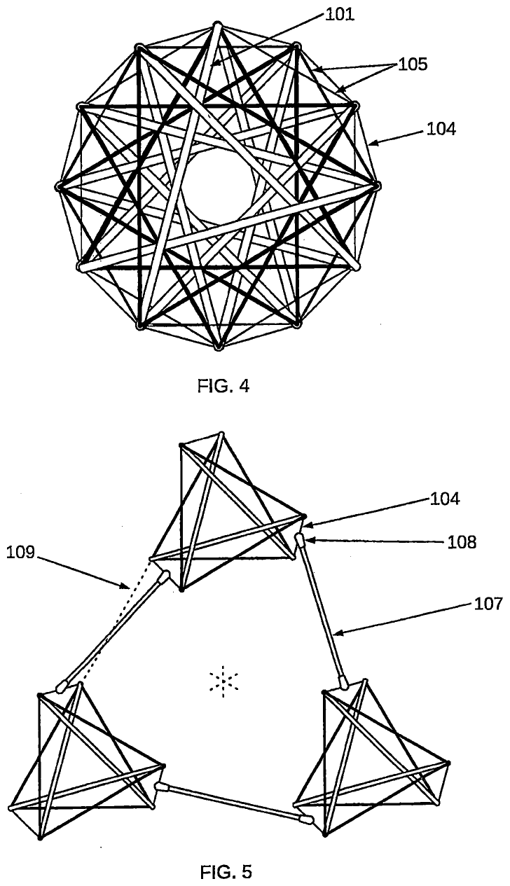

It is further noted that as the module rotation angle compounds across successive tiers within a column, the orientation of the top-tensile elements of any given tier progressively harmonizes with the orientation of the bottom-tensile elements of the tier above, a property of direct relevance to the coordination of reflective membranes and programmatic layer boundaries as described below. [FIG. 4]

In certain embodiments it may be desirable to vary the inter-tier overlap dynamically—for example, to allow a column to extend or compress in height in response to applied pressure or mechanical actuation. In such embodiments, the inter-tier tensile elements may incorporate elastic materials or mechanically flexible designs that allow the overlap to vary within a prescribed range while maintaining the non-contacting interpenetration of compressive elements. Where the inter-tier overlap varies significantly, the position of top and bottom tensile elements of the module being interpenetrated relative to the encroaching compressive elements changes accordingly, and a mechanical guide may be introduced to manage this variation without damage to the tensile elements or loss of module positioning. One such guide is a foil guide: a single- or double-banded component that steers the top and bottom tensile elements toward the central axis of the module, away from the compressive elements, accommodating a range of inter-tier overlap while preserving the tensile nature of the connection and minimizing thermal contact between the guide and the compressive elements. [FIG. 3]

The interpenetrating column geometry further enables a collapsed or inactive mode in which the inter-tier tensile elements are relaxed so that adjacent modules are drawn together along the column axis until their compressive elements rest upon one another, reducing the column's overall height to a fraction of its active height and correspondingly reducing the total internal volume of the framework. This collapsed mode is of particular relevance to collapsible and deployable embodiments, and further advantageous in evacuated panel embodiments where reduced internal volume improves evacuation efficiency. The transition between collapsed and active states may be controlled by the elastic properties and yield characteristics of the inter-tier tensile elements, by mechanical stops integrated into the spacer system, by mechanical or electromechanical tensioning mechanisms that dynamically adjust inter-tier tensile element length, or by external actuation. Embodiments designed to expand from a collapsed state after sealing and partial or full evacuation must account for the significant compressive force exerted by atmospheric pressure across the total surface area of the hermetic envelope, which resists expansion along the column axis; the mechanical force required to achieve and maintain the active state geometry must meet or exceed this atmospheric load across the full lateral extent of the panel.

### Spacers, Inter-column Spans, and Open and Closed Connection Patterns

Columns assembled in the manner described above are laterally interconnected by spacers to form column groupings that may be tiled to produce a layer of desired lateral dimensions. The spacer extends laterally between adjacent columns and connects mechanically to a mid-tensile element in each of the columns it joins at a position governing inter-column spacing. Spacers may perform compressive functions, tensile functions, or both, depending on the embodiment—this dual capacity is what enables the spacer to serve as the primary mechanism of flexibility control across a layer.

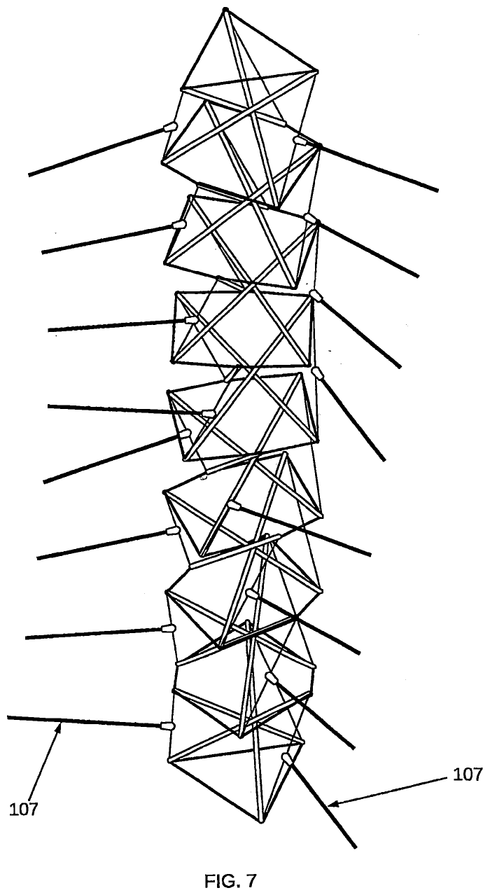

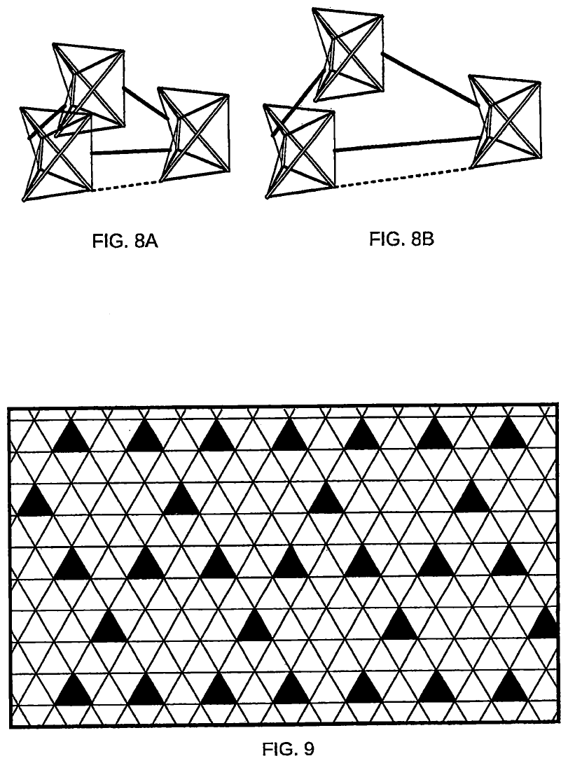

The lateral distance between adjacent columns as measured between the nearest points in the circles containing the compressive endpoints of the same tier is referred to as the inter-column span, a measurement that may be taken at any tier but most naturally reflects the spacing between column footings. The spacer length will in general differ from the inter-column span, because the spacer must accommodate the angular geometry of the mid-tensile elements at their midpoints. The relationship between spacer length and inter-column span is accordingly a function of the module height, module span, module rotation angle, and mid-tensile element geometry. [FIG. 8A and FIG. 8B]

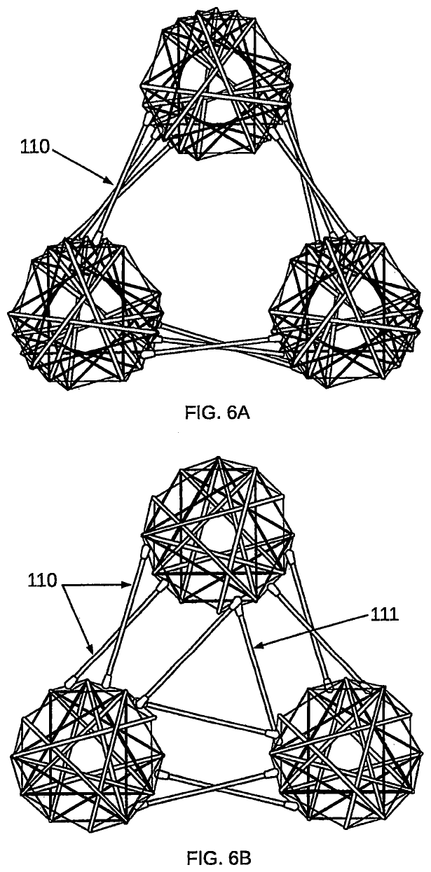

Spacers connect columns with a preference for mid-tensile elements facing most toward the center of the column grouping. For n=3 groupings, reciprocal mid-tensile elements of adjacent columns may align to produce open or closed connection patterns depending on the module rotation angle and cumulative rotational offset across successive tiers. In open patterns, spacer endpoints are distributed across six distinct mid-tensile attachment points. In closed patterns, spacers share only three attachment points, introducing a localized area of increased structural density and correspondingly increased potential for conductive thermal bridging. The pattern inverts laterally from one column grouping to the next across the layer, and spacer patterns along a single column grouping may be mixed across tiers. [FIG. 6A and FIG. 6B]

Various tiling patterns may be produced by varying the inter-column span, module rotation angle, and spacer connection pattern. A basic equilateral tiling pattern produces a regular hexagonal or triangular lateral network depending on the column grouping geometry. More complex tiling patterns may combine column groupings of different inter-column spans to produce spatially graded structural density. Fractal compounding of column groupings is described further in the programmatic layer section below. [FIG. 9 illustrates a basic equilateral tiling pattern produced by repetition of a triangular three-column grouping. FIG. 5 illustrates a basic grouping of three columns joined by spacers via rotational compliance fittings, showing the spatial relationship between columns, spacers, and inter-column span in plan view.]

Fulcrum-Tier Flexibility Mechanism, Peripheral Spacers, and Positional Memory The arrangement and mechanical properties of spacers across the tiers of a layer constitute the primary means by which controlled flexure is achieved in the column-and-spacer embodiment. A rigid layer may be produced by populating all available tiers with spacers of fixed length. Flexibility is introduced by designating one tier as a fulcrum populated with spacers of fixed length—referred to herein as fulcrum spacers—and assigning to some or all of the remaining tiers spacers whose mechanical properties permit a defined range of lateral displacement proportionate to their distance from the fulcrum tier.

The fulcrum spacers establish a fixed lateral reference plane around which the outer regions of the layer may pivot under bending force. As the inter-column space on one side of the fulcrum increases under bending, the inter-column space on the opposite side decreases by a reciprocal amount, preserving the overall lateral volumetric integrity of the layer. The tiers above and below the fulcrum tier are populated with peripheral spacers having a defined range of length—a minimum compressive length and a maximum tensile length—rather than a fixed length, with the range of each peripheral spacer proportionate to its distance from the fulcrum tier. The collective effect is that the layer may curve in three dimensions while each column maintains its structural integrity and the fulcrum plane maintains its average inter-column spacing. [FIG. 11]

It is further noted that a peripheral spacer constitutes a single mechanical component configurable across a continuous range of operative lengths between its minimum compressive length and its maximum tensile length. The expanded and contracted states illustrated in FIG. 11 represent two positions of the same peripheral spacer component under different loading conditions, not two distinct components.

The flexibility of a layer may be made asymmetric by assigning different ranges of length to the peripheral spacers on opposite sides of the fulcrum tier, or by specifying different rest lengths or spring constants on opposing sides. The position of the fulcrum tier within the layer's depth determines the geometric relationship between the two pivoting regions but does not itself produce asymmetric flex resistance in the absence of differential spacer or external layer constraints. A fulcrum tier positioned at the geometric center of the layer's depth distributes the difference in surface area between the layer's opposing faces equally between those membranes, minimizing the differential demand on either membrane during flexure and serving to maintain continuous layer volume across flex states.

Peripheral spacers may additionally incorporate mechanical positional memory through elastic or spring components whose rest length corresponds to the inter-column spacing at the desired neutral curvature, so that the layer passively returns to its neutral curvature when external bending forces are removed. The restoring force is tunable across a range from nearly free articulation to near-rigid positional memory. [FIG. 11]

Spacers need not occur uniformly across a layer. Spacers may be omitted from selected tiers entirely, or may alternate between the n available lateral directions at a given tier, lowering structural complexity and material cost while preserving the essential fulcrum-tier flexibility mechanism. [FIG. 7 illustrates an eight-tier column with two spacers branching from each module, showing the distribution of spacer connections across successive tiers of a single column.]

### Column Groupings, Tiling Patterns, and Fractal Layer Scaling

A layer of desired lateral dimensions is produced by tiling column groupings across the plane perpendicular to the columns' directional axis. The simplest column grouping for an n=3 module is a triangular arrangement of three columns with spacers connecting each column to its neighbors at each populated tier, constituting the fundamental repeating tile for an equilateral tiling pattern. More complex column groupings may be employed where the programmatic objectives of a given embodiment require non-uniform lateral structural density, directionally differentiated mechanical properties, or specific electromagnetic or acoustic spatial periodicity. [FIG. 9]

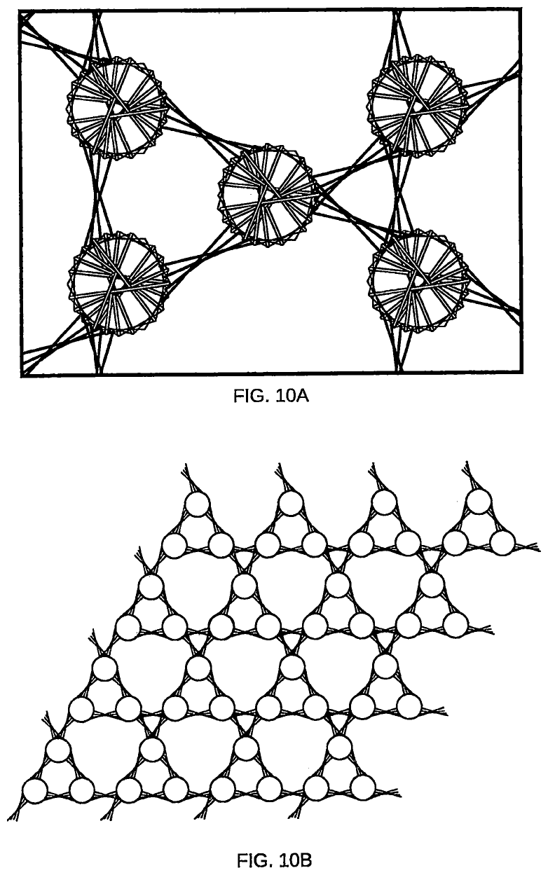

The inter-column span need not be uniform across a layer. A span greater than the module span may produce a more open lateral network with lower structural density and greater evacuable void fraction per unit area, while a span approaching the module span produces a denser network with greater structural redundancy. Within a single layer, the inter-column span may vary spatially to produce regions of greater density at the layer's perimeter and a more open interior, or to concentrate structural density at locations of anticipated mechanical stress concentration. [FIG. 10A, FIG. 10B, and FIG. 10C]

Fractal compounding of layers offers a further degree of structural and functional adaptability. In a fractally compounded configuration, a primary layer is augmented by one or more additional layers whose module span, module height, and inter-column span are scaled in approximate proportion by a chosen ratio, with the scaling ratio and lateral positioning selected so that the endpoint of each compressive element in one layer aligns with or is supportable by the central axis of a corresponding column or column grouping in the adjacent scaled layer, producing a hierarchical load-transfer relationship between layers. This correspondence relationship may be reiterated across multiple layers in either direction of scale, with the scaling ratio varying between successive layers and the spatial arrangement of scaled layers interleaved within a shared plane, stacked in discrete facewise layers, or combined in both arrangements simultaneously.

A fractally compounded configuration may combine layers of different module rotation angles, different tensile element materials, or different spacer arrangements, so that each layer in the fractal hierarchy contributes distinct structural, thermal, or functional characteristics to the combined panel, providing the structural foundation for the programmatic layer configurations described in the sections that follow.

### Programmatic Layers, Electromagnetic Functions, and Reflective Membrane Interleaving

The layer architecture of the present framework provides a substrate for a wide range of performance objectives beyond basic thermal insulation. By varying component geometries, module rotation angles, inter-column spans, tier counts, material compositions, and surface treatments systematically across the modules and tensile elements of a given layer, an embodiment may be configured to emphasize specific structural, thermal, electromagnetic, or acoustic properties while maintaining the shared tensegrity module foundation. Multiple layers of different programmatic character may be combined within a single panel, each contributing its specific functional characteristics to the panel's overall performance profile.

A particularly significant programmatic application is the configuration of one or more layers as electromagnetic functional elements. By selecting compressive and tensile element dimensions so that the resulting geometric periodicities correspond to harmonic resonances at desired electromagnetic frequencies, a given layer may be configured to interact selectively with electromagnetic radiation at those frequencies across a range spanning radio, microwave, and higher frequencies. The compressive elements' surfaces may further serve as substrates for conductive surface treatments—including printed traces, coiled conductors, conductive coatings, or other conductive surface modifications—that enhance, modify, or extend the electromagnetic interaction of the layer beyond what the bare geometric periodicity provides.

Because each compressive element occupies a specific angle of incidence relative to the layer's surface, and because this angle varies systematically with the module rotation angle and tier position, the material composition of compressive elements may be varied selectively to produce spatially anisotropic electromagnetic responses including amplification, attenuation, shaping, plasmonic coupling, or focusing of electromagnetic energy in desired directions. The dynamic flexibility of the layer further enables embodiments in which the electromagnetic response is tunable in use by controlled variation of the layer's curvature. In embodiments employing fractal layer compounding, the hierarchical correspondence of compressive element endpoints with column axes across scaled layers produces a three-dimensional fractal antenna geometry whose resonant characteristics span multiple frequency decades determined by the scaling ratios between layers.

Radiant heat transfer between opposing faces of the framework may be reduced by the interleaving of reflective membranes within the layer structure. A reflective membrane—such as an aluminized film or other low-emissivity sheet material—may be embedded between any two adjacent tiers within a layer, or between two adjacent layers, so as to intercept and reflect radiant energy propagating facewise through the framework without significantly impeding evacuation. To facilitate evacuation while maintaining reflective function, reflective membranes may incorporate perforations, apertures, or other discontinuities that provide gas flow pathways. The orientation of the top-tensile and bottom-tensile elements at each tier boundary—which harmonizes progressively across successive tiers as a function of module rotation angle—provides a natural coordinate system for the attachment or registration of reflective membranes at tier boundaries, facilitating precise membrane placement and preventing migration under dynamic flex conditions.

The same structural variability that enables electromagnetic configuration also provides the basis for acoustic programmatic layers, as described in paragraph [0021], and for structural programmatic layers configured to provide specific mechanical responses to dynamic environmental stresses, including impact absorption, vibration isolation, and pressure-driven actuation.

### Packed-Core Embodiment: General Principles and Categories of Packed Module

In an alternative embodiment, the tensegrity framework is realized as a packed core comprising a plurality of discrete modules assembled without fixed inter-module connections within a defined volume or layer. Rather than organizing modules into oriented columns laterally interconnected by spacers, the packed-core embodiment relies on the geometric properties of the individual module to produce a collectively stable aggregate whose mechanical and thermal performance emerges from the interaction of many modules in contact or near-contact with one another. A single standardized module design may be produced in high volume and distributed into an enclosing envelope by pouring, vibration, careful placement, or other filling methods, making the packed-core embodiment particularly well suited to large-area panels, irregularly shaped panels, and applications where manufacturing simplicity and cost are primary considerations.

A fundamental distinction exists between two categories of module suitable for packed-core embodiments. In the first category, each module embodies genuine tensegrity equilibrium internally: compressive elements are held in their spatial arrangement solely by intra-module tensile elements without direct contact, and the aggregate exhibits tensegrity behavior at both the module level and the system level simultaneously. In the second category, the compressive elements of a single module are joined into a unified rigid form whose internal structural integrity is provided by the rigid form itself rather than by tensile elements. Tensegrity conditions are absent at the individual module level but emerge collectively when many such rigid modules are packed together, with compressive loads distributed discontinuously across the rigid module bodies and tensile forces transmitted through contact points or the confining pressure of the hermetic envelope.

Both categories produce a discontinuous compressive network in which solid conduction pathways between opposing faces of the panel are confined to the contact geometry between module bodies, producing a distributed thermal bottleneck analogous in principle to the tiered thermal bottleneck of the column-and-spacer embodiment. The choice between categories depends on the intended application, manufacturing cost targets, desired mechanical isotropy, and the specific module geometry employed.

Where the module geometry produces a sufficiently stable interlocking arrangement under atmospheric compressive load, the hermetic envelope itself provides the confining force that maintains the aggregate in its operative configuration. In embodiments where greater structural stability is desired, adjacent modules may be fastened by tying, knotting, crimping, adhesive bonding, or equivalent means, provided that the fastening means does not introduce direct compressive bridges between compressive elements at points other than their designed contact geometry. The envelope and any intermediate protective layers must transmit atmospheric compressive load to the module aggregate without concentrating stress at individual module contact points to a degree that would cause compressive element failure.

The packed-core embodiment encompasses a broad family of module geometries sharing a common structural principle: six compressive elements arranged as three pairs, each pair straddling a shared central origin, the three pairs disposed in mutually non-coplanar orientations, with the twelve resulting endpoints distributed in three-dimensional space. Many polyhedral geometries satisfy this condition, including arrangements derived from the icosahedron and other forms whose twelve vertices can be organized to serve as endpoints for three non-coplanar compressive pairs straddling a shared origin. A particularly advantageous geometry within this family is the tensegrity analog of the first stellation of the rhombic dodecahedron, which additionally provides the space-filling packing properties described below.

### Escher Module Geometry: Base Form, Plane and Rank Definitions, and Design Considerations

A particularly advantageous module geometry for packed-core embodiments is a tensegrity analog of the first stellation of the rhombic dodecahedron, known informally as Escher's solid, whose stellated point geometry produces an interlocking packing arrangement derived from the rhombic dodecahedron's space-filling properties. The tensegrity analog replaces the solid material of the stellated form with an open compressive-tensile structure of minimal solid volume, preserving the essential engagement geometry while maximizing the evacuable void fraction of the aggregate core.

For the purposes of describing the module and its design variables, any two diametrically opposite points of the module's twelve endpoints may be selected to define a diametric axis, and the circumscribed sphere is defined as the sphere passing through all twelve endpoints with its center at the module's origin. The twelve endpoints distribute, with respect to the selected diametric axis, into five distinct parallel planes orthogonal to that axis, illustrated in FIG. 13A and FIG. 13B with indicating arrows bearing reference numerals 201 through 205 respectively:
The base plane (201) contains the single originating diametric endpoint. It has one point and no connections within the plane.
The near plane (202) is parallel to the base plane, positioned evenly between the base plane and the mid plane. It contains four points. Lines from the originating point to near-plane points are equal to the radius of the circumscribed sphere.
The mid plane (203) is parallel to the base plane and positioned at the origin of the solid. It contains two points. Lines from the originating point to mid-plane points are greater than the radius of the circumscribed sphere.
The far plane (204) is parallel to the base plane, positioned evenly between the mid plane and the diametric plane. It contains four points. Lines from the originating point to far-plane points are greater than the radius but less than the diameter of the circumscribed sphere.
The diametric plane (205) contains the single diametrically opposite endpoint. It has one point. The line from the originating point to this point equals the diameter of the circumscribed sphere and passes through the origin.

Based on this planar framework, the point-to-point connection categories from any given originating point are classified into four ranks, each defined by the plane in which the connected point resides and the unique connection geometry that plane produces:
A diametric connection (201-to-205) has a length equal to the diameter of the circumscribed sphere, connecting the originating point to the single point in the diametric plane through the origin. One such connection exists per originating point.
A far connection (201-to-204) has a length greater than the radius but less than the diameter of the circumscribed sphere, connecting the originating point to one of the four points in the far plane. Four such connections exist per originating point.
A mid connection (201-to-203) has a length greater than the radius of the circumscribed sphere, connecting the originating point to one of the two points in the mid plane. Two such connections exist per originating point.
A near connection (201-to-202) connects the originating point to one of the four points in the near plane. Four such connections exist per originating point. Lines of near rank run furthest from the origin relative to all other connection ranks. Near connections are equal in length to the radius of the circumscribed sphere.

The four ranks account for one diametric, four far, two mid, and four near connection categories —eleven distinct connection relationships in total from any given originating point, accounting for all other eleven points in the module.

The geometric framework described above—the circumscribed sphere, the five planes, and the four connection ranks—is adopted as an ideal reference geometry for the purposes of description and claim construction, and should not be construed to limit the invention to modules whose compressive element endpoints correspond exactly to the points of the canonical first stellation of the rhombic dodecahedron. The rank and plane vocabulary described above applies equally to module variants whose endpoint geometry departs from the ideal solid through variation of compressive element length, straddle distance ratio, aspect ratio, or pairing symmetry, with the ideal first stellation serving as a geometric reference rather than a prescriptive constraint. For the purposes of this description and the appended claims, a ‘topologically similar form’ refers to any six-element, three-pair, twelve-endpoint geometry that preserves: (i) the arrangement of three compressive pairs each straddling a shared central origin by a characteristic offset distance; (ii) the disposition of the three pairs in mutually non-coplanar orientations such that no two pairs share a common plane; and (iii) the non-contact condition between compressive elements within the module—regardless of the angular relationships between pairs, the specific polyhedral reference to which the endpoint distribution corresponds, or variation in compressive element length, straddle distance ratio, aspect ratio, or pairing symmetry.

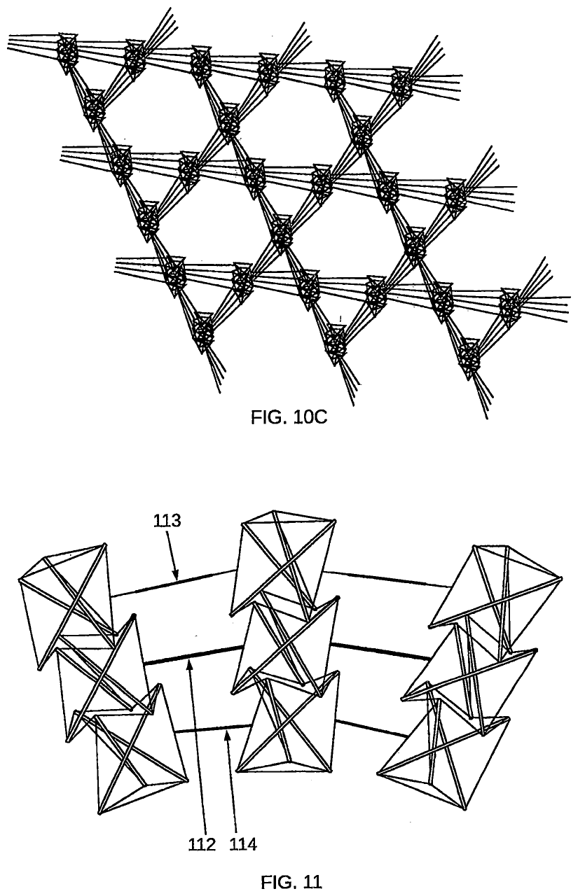

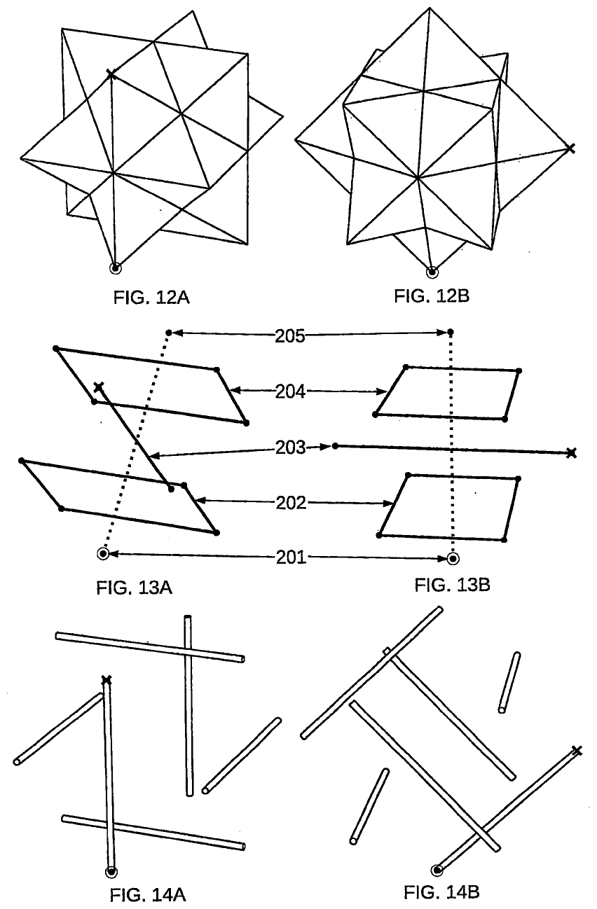

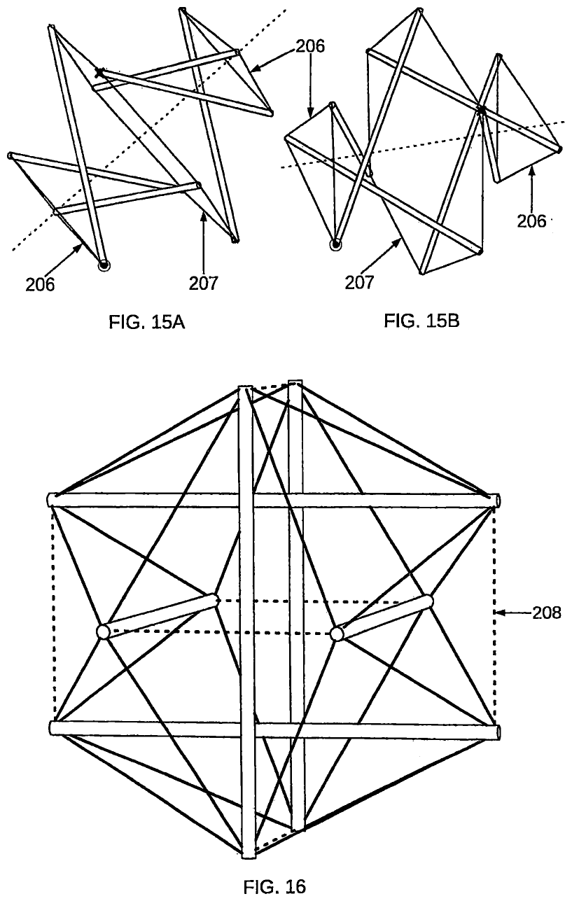

The tensegrity analog comprises six compressive elements arranged as three pairs, each pair oriented so that its two parallel members straddle the shared central origin by a characteristic offset distance, with the twelve endpoints of the six elements collectively positioned in correspondence with the stellated points of Escher's solid or of a variant form as defined above. The primary design variables are the length of the compressive elements, the ratio of straddle distance to compressive element length for each pair—which governs internal clearance between compressive pairs at their crossing lines and may be varied independently across pairs —the number, pattern, and yield characteristics of the tensile elements, and the rigidity and deflection characteristics of the compressive elements under load, all of which may be adjusted to tune the module's engagement geometry and chordal clearance for the performance objectives of a given embodiment. FIGS. 12A and 12B illustrate the first stellation of the rhombic dodecahedron. FIGS. 14A and 14B illustrate the tensegrity analog module in the same perspective, scale, and orientation, with compressive element endpoints positioned at the corresponding twelve points.

Two primary compressive pairing symmetries are available, defined by the rank of the connections used to position the compressive pairs. In an orthogonal pairing, the compressive pairs are drawn between parallel sets of mid-rank (201-to-203) connections, with each pair's endpoints terminating in the mid plane. Orthogonal pairings produce greater average offset of the compressive elements from the origin, running closer to the spherical outer bounds of the circumscribed sphere, and produce wider internal clearance at the crossing lines between pairs. In a non-orthogonal pairing, the compressive pairs are drawn between parallel sets of far-rank (201-to-204) connections, with each pair's endpoints terminating in the far plane. Non-orthogonal pairings trend closer to the origin, producing narrower internal clearance at crossing lines and greater average inter-module compressive separation in the packed aggregate—a property useful for probabilistic contact determination in bulk irregular packing and for radiative heat transfer estimation in designs not employing reflective layers. Near-rank (201-to-202) connections are not employed as compressive pairing candidates in either primary symmetry; they are available as tensile configuration points within the twelve-point attachment space. Mixed or intermediate pairing geometries, in which compressive pairs are drawn using connections of different ranks across the three pairs, are also contemplated within the scope of the present invention. FIG. 14A and FIG. 14B illustrate the orthogonal compressive pairing and FIG. 15A and FIG. 15B illustrate the axial compressive pairing, together showing the difference in average offset from origin between the two arrangements.

It is a practical consequence of the tensile elements' function that a module assembled at the ideal Escher's Solid endpoint geometry with orthogonal arrangements of compressive elements will experience inward deflection of its compressive elements toward the origin under tensile pre-tension, departing from the ideal geometry by an amount determined by the pre-tension magnitude, the stiffness of the compressive elements, and the tensile element configuration. The adjustable straddle distance ratio—the ratio of compressive pair offset distance from the origin to compressive element length—serves as the primary design variable for compensating this inward deflection, allowing the fabricated module geometry to approximate the ideal endpoint positions under operating pre-tension conditions. A further consequence of the ideal Escher's Solid geometry is that each compressive element, at its ideal position, obstructs one potential tensile connection path among the twelve attachment points, yielding six obstructed connections in total for the orthogonal arrangement. Inward offset of the compressive pairs from the ideal geometry—as illustrated in FIG. 16—simultaneously compensates for tensile pre-tension deflection and clears these six obstructed connection paths, making them available as additional tensile routing options. The connections made available through inward offset are identified in FIG. 16 as (208). In the axial arrangement, no such obstructions are present at the ideal geometry, and all possible tensile connections among the twelve attachment points are available without geometric inward offset.

A particular variant of the inset module geometry is achieved when the distance between the compressive elements of a pair is set uniformly across all three pairs to a value bearing a golden ratio relationship to the compressive element length—that is, when the ratio of straddle distance to compressive element length equals approximately 0.618 or its reciprocal 1.618. This specific proportional relationship causes the twelve endpoints of the module to correspond to the twelve vertices of an icosahedron, yielding the icosahedral module variant illustrated in FIG. 18. The icosahedral module is accordingly a special case of the inset orthogonal module in which the golden ratio proportions of the compressive pairs produce icosahedral geometry. A continuous range of straddle distance ratios is available across ideal Escher's Solid geometry and the icosahedral geometry, each producing a distinct endpoint distribution, packing geometry, and tensile routing space, enabling programmatic design of the aggregate's mechanical, thermal, and electromagnetic properties across a continuous geometric continuum.

The unified solid variant of the Escher module constitutes the second category of packed module described in the preceding section. In this variant, the three pairs of parallel compressive elements are joined into a single rigid form—most naturally conceived as three mutually oriented rectangles sharing a common center, with one set of opposing edges for each rectangle corresponding to the compressive element pair of that plane. Tensile elements are present as components of this module, connecting the endpoints of the rigid form, but the rigid body provides all internal structural integrity and tensegrity conditions do not exist within the individual module. Tensegrity conditions emerge at the inter-module level: when many such modules are packed together, contact between adjacent modules occurs primarily at the abutting of their respective tensile elements rather than at compressive endpoints, producing discontinuous compression through rigid bodies and tension through abutting tensile element contacts—tensegrity behavior at the system level. This inter-module spacing may be further improved with the addition of near-rank (201-to-202) tensile connections which push modules further apart than the closest space-filling mode of the ideal first stellation of the rhombic dodecahedron. The aspect ratio of the rectangles is a continuous design variable not limited to any particular illustrative example. FIG. 19A illustrates the unified solid variant showing the three mutually oriented rectangle construction and representative aspect ratio variants. In one embodiment, the long edges of each rectangular block present concave scalloped profiles, clearing tensile connection paths that would otherwise be obstructed by straight long edges at the ideal Escher's Solid geometry.

### Escher Module Packing Behavior, Chordal Clearance, Foil Guide Analogue, Radiant Heat Reduction, and Periodic Cavities

When Escher modules are brought into contact under compressive loading, the stellated point geometry of the module naturally tends toward origin-proximity between neighboring modules as a stable configuration. This tendency may be further designed and guided through selective addition of tensile elements among the twelve attachment points. Tensile chords spanning between compressive endpoints may be configured to produce reciprocal inter-module mating surfaces and are thus configurable inter-module mating lines in three dimensions. The aggregate accordingly tolerates a range of packing arrangements—from carefully ordered to probabilistic —with the designed tensile chord geometry providing a consistent mating tendency across that range, and the chordal clearance governing the proximity of neighboring module origins in the packed aggregate.

The tensile chord geometry available for configuring inter-module mating surfaces is directly governed by the number, rank and position of the connections employed. Near-rank (201-to-202) connections, whose lines run furthest from the origin relative to all other ranks, produce the shortest tensile chords relative to the circumscribed sphere and most define the outermost engagement boundary of the module. Accordingly, they are primary candidates for inter-module mating surface configuration. Mid-rank (201-to-203) and far-rank (201-to-204) connections produce tensile chords that run closer to the origin along their length and may be employed to configure mating surfaces at intermediate engagement depths. The selection and placement of various tensile connection ranks for inter-module mating surface configuration is accordingly a design variable governing the aggregate's packing behavior, chordal clearance profile, and mechanical response under compressive loading.

The proximity of the origins of neighboring modules, as a general rule, will be less than that of their respective circumscribed spheres put into contact. This difference is designated herein as the chordal clearance. The chordal clearance is governed by the tensile elements' chord geometry and constitutes a primary design variable affecting packing density, inter-module contact stress, and thermal contact resistance across the aggregate. Notably, the chordal clearance of modules can be reduced beyond that of the stellated depth of the first stellation of the rhombic dodecahedron through the addition of near-rank tensile connections.

A guide component analogous to the foil guide of the column-and-spacer embodiment may be introduced to govern tensile chord geometry with greater precision, fastened at one or more of the module's twelve attachment points, or to defined points along other intra-module tensile components, so as to deflect selected intra-module tensile elements at various angles toward or away from the origin. This offset may be uniform across all planes of the module, producing a regular and symmetric engagement geometry, or may vary independently across planes, producing irregular or asymmetric shape suited to directionally differentiated packing behavior or programmatic objectives. The offset of the tensile chord geometry is thus a configurable parameter affecting the chordal clearance: offset towards origin increases the chordal clearance, while offset away from the origin decreases it toward that of the circumscribed spherical ideal.

Where inter-module connections require controlled pivoting, directional constraint, or reduced frictional wear on tensile elements at contact points, a bearing or equivalent rotational compliance component may be introduced about the abutting tensile lengths of adjacent modules, governing pivot geometry and decoupling rotational motion from the tensile elements at their shared contact point.

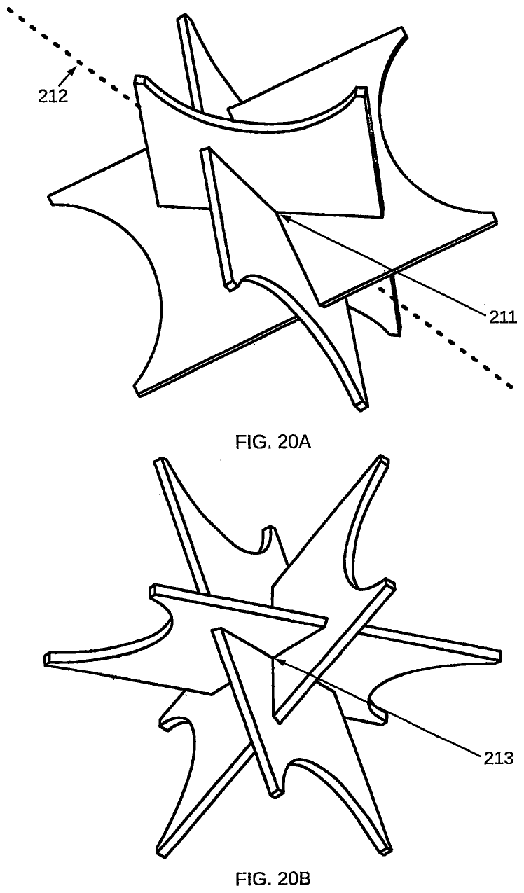

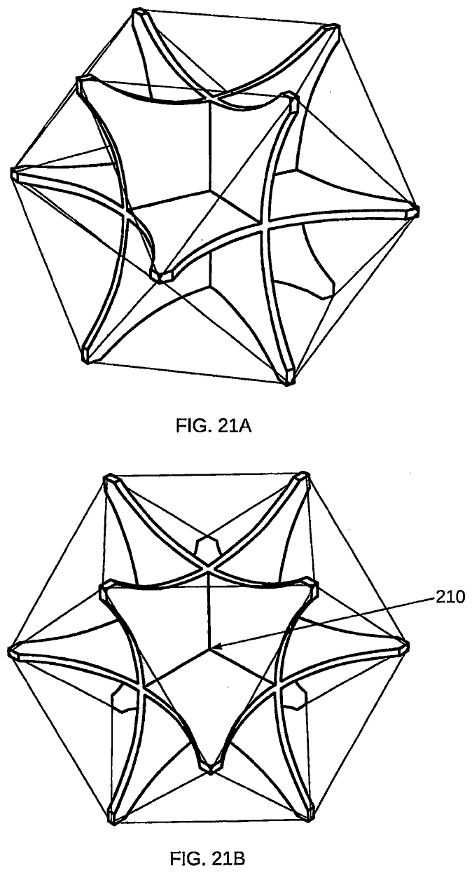

Radiant heat transfer through the packed-core aggregate may be reduced by the application of reflective surface treatments to the module bodies. In the unified solid variant, the outer surfaces of the rigid rectangular forms may be treated with a low-emissivity coating—such as aluminized film, vapor-deposited metal, or equivalent reflective surface treatment—so that the packed aggregate presents a multiplicity of reflective surfaces at varied orientations and depths. Photon paths propagating facewise through the aggregate encounter successive reflective surfaces at irregular angles, producing a distributed scattering effect analogous in function to the interleaved reflective membranes of the column-and-spacer embodiment but arising from the module geometry itself rather than from discrete membrane layers. In the first category of Escher module, an equivalent effect may be achieved by interposing reflective elements, films, or coatings within or between modules in the aggregate. [FIG. 19B, FIG. 20A, FIG. 20B, FIG. 21A, and FIG. 21B illustrate the trihedral corner reflector geometries of the orthogonal and axial unified solid module variants with reflective surface treatment.]

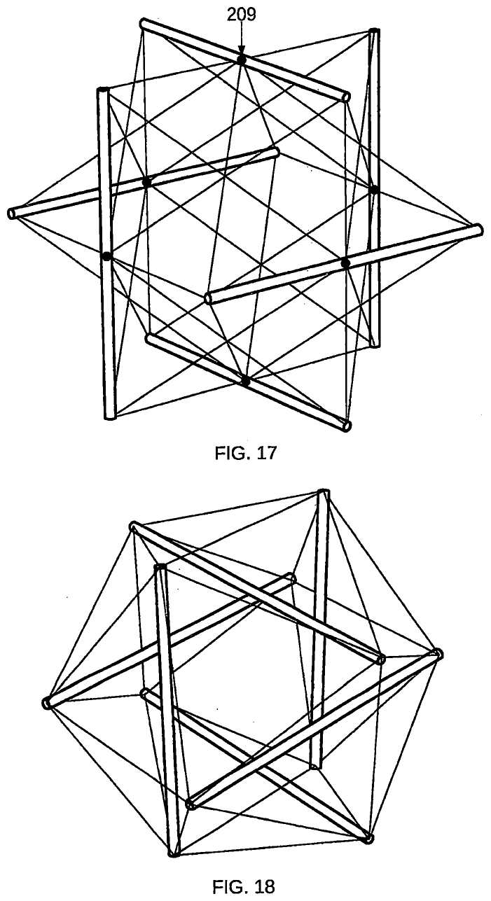

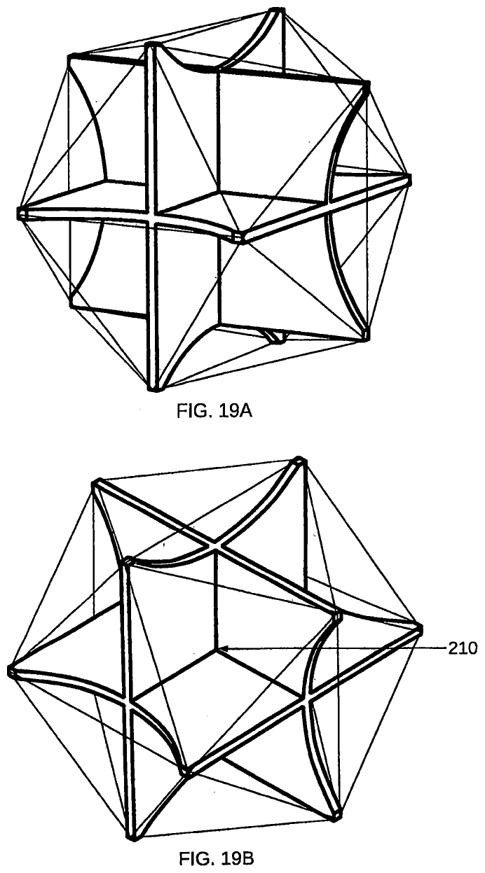

By deliberate design of module geometry, compressive element length, straddle distance ratio, and packing orientation, adjacent modules within a packed aggregate may be arranged so that the endpoints of compressive elements of one module abut the endpoints or spans of compressive elements of neighboring modules in controlled, directionally specific patterns. Where such end-to-end or span-to-endpoint abutment is designed into the packing geometry, continuous or semi-continuous conduction pathways for thermal energy, electrical current, or magnetic flux are established through the aggregate along the axes of abutment, while the discontinuous character of the packed-core structure is preserved in non-abutting directions. This capacity for designed directional conduction pathway introduction enables programmatic assignment of conduction axes within the aggregate—specifying one spatial axis as a thermal conduction pathway while maintaining thermal discontinuity in the two transverse axes, for example—and is directly relevant to the three-axis material role assignment of the ANE embodiment described in paragraph [0027], where the thermal gradient, magnetization, and collection axes each require distinct material assignment along defined spatial directions. In certain embodiments, tensile elements may be connected not between compressive endpoints but between the midpoint of one compressive element and the endpoint of another, producing tensile chord geometry that more closely follows the surface contour of the ideal first stellation and enabling controlled abutment geometries not achievable through endpoint-to-endpoint connections alone. [FIG. 17 illustrates this midpoint tensile connection configuration, showing connection locations at the midpoints of compressive elements coinciding with the near plane and mid plane relative to the originating point.]

The retroreflective properties of the packed-core aggregate are governed by the angular geometry of the module arrangement. In the orthogonal arrangement, the three mutually perpendicular compressive pairs instantiate the geometry of a trihedral corner reflector—three mutually orthogonal reflective surfaces meeting at a common origin—which returns incident radiation precisely back toward its source regardless of angle of incidence across a wide solid angle, through the triple-bounce reflection mechanism characteristic of corner retroreflectors. In the axial arrangement, and particularly in embodiments with compressive ends positioned along polar circles closer-to or further-from the geometry of the ideal Escher's Solid, the angular departure from orthogonality between compressive pairs produces a calculable and designable angular redirection of incident radiation rather than precise retroreflection. A packed aggregate combining orthogonal and axial modules accordingly produces a controlled mixture of retroreflection and directional scattering whose character is programmable through the relative proportions and orientations of orthogonal and axial modules within the aggregate. This distributed retroreflective and scattering behavior—arising from the module geometry itself rather than from discrete membrane layers—constitutes a reflective metamaterial effect in which the bulk radiative properties of the aggregate are determined by the geometry and spatial distribution of the individual module units rather than by the intrinsic surface properties of their constituent materials. Operating at the scale of the module geometry relative to the incident wavelength, this geometric-scale electromagnetic programming produces retroreflective, directionally redistributive, or scattering behavior depending on the angular geometry of the module arrangement and the ratio of module dimensions to incident wavelength—enabling the same structural aggregate to exhibit distinct electromagnetic responses across different frequency regimes by geometric scaling of the module dimensions, and constituting a programmable radiative property whose character is governed by module geometry, surface treatment, and packing orientation rather than by bulk material selection alone.

Regular cavities—volumes from which modules are systematically omitted or replaced—may be introduced into the packed-core aggregate along all three spatial axes to achieve structural, thermal, electromagnetic, or acoustic objectives. The spatial periodicity of the cavity arrangement is governed by the packing lattice geometry of the module and the positions selected for omission or substitution, and may be designed to produce resonant periodicities, preferential evacuation pathways, or regions of reduced effective density as required by the programmatic objectives of the embodiment. In embodiments combining packed-core and column-and-spacer approaches at different scales, regular cavities may be dimensioned to correspond to the column spacing of an adjacent column-and-spacer layer, producing structural and functional correspondence between the two embodiments at their shared layer boundary.

Beyond passive packing arrangements, Escher modules may be fastened to one another—by tying, knotting, crimping, adhesive bonding, or equivalent means appropriate to the material and scale of the embodiment—to produce deliberately organized three-dimensional structures. The Escher module's stellated geometry makes it a particularly versatile three-dimensional building block: fastened assemblies of Escher modules may produce column-like structures, fulcrum arrangements, and spatially graded mechanical networks analogous in function to the column, fulcrum tier, and spacer system of the column-and-spacer embodiment, realized through the three-dimensional engagement geometry of the module rather than through the oriented linear column architecture. The range of angular displacement permitted at each fastened inter-module connection—and accordingly the overall flexibility of the fastened assembly—may be governed by tensile stoppages spanning between non-adjacent modules, whose governed length defines the maximum displacement permitted across the connections they span, in a manner analogous to the peripheral spacer stoppages of the column-and-spacer embodiment.

### Acoustic Programmatic Layer Extension

The structural and material variability inherent to the programmatic layer architecture extends beyond thermal and electromagnetic functions to provide a basis for selective acoustic performance. The mechanical transmission of vibrational energy through the tensegrity framework is governed by the same tensile bottleneck that constrains thermal conduction: vibrational energy propagating facewise through the framework must pass through the tensile elements connecting compressive members across modules and tiers, and the cross-sectional area, material composition, length, and pre-tension of those elements directly determine the framework's transmission characteristics at given frequencies. By tailoring these parameters across a discrete layer—for example, by varying tensile element material or geometry across tiers to introduce destructive interference at target frequencies, or by incorporating viscoelastic tensile elements in selected tiers to introduce damping—a given embodiment may be configured to selectively attenuate, isolate, or transmit acoustic vibration. This capability is further enhanced in evacuated embodiments, where the absence of airborne conduction removes the dominant acoustic transmission pathway of conventional insulating panels, leaving mechanical transmission through the tensegrity framework as the primary controllable variable. Accordingly, the framework's programmatic layer architecture extends naturally to acoustic performance objectives, including broadband isolation, selective frequency damping, and tunable resonance, as distinct programmatic goals achievable within the same structural platform as thermal and electromagnetic functions.

### Vacuum Membrane and Manifold Underlayment

The tensegrity framework core, in embodiments configured as a vacuum-insulated panel, is enclosed within a hermetic envelope referred to herein as the vacuum membrane. The vacuum membrane must satisfy three principal requirements simultaneously: it must maintain a hermetic seal sufficient to preserve the internal vacuum pressure for the service life appropriate to the embodiment; it must resist deformation under the inward compressive force of atmospheric pressure acting on its outer surface; and it must accommodate the range of flexure, if any, required by the embodiment without fatigue failure of the hermetic seal. These requirements are in partial tension with one another—materials of high impermeability tend toward rigidity, while materials of high flexibility tend toward greater gas permeability—and the vacuum membrane is accordingly designed as a composite of several discrete layers, each contributing specific properties to the combined assembly, rather than as a single monolithic material.

A typical vacuum membrane composite may include one or more of the following functional layers in combination: a gas-impermeable layer, such as a metallic foil or aluminized film, providing the primary hermetic barrier; a structural layer, such as a woven fabric or fiber-reinforced film, providing resistance to puncture, abrasion, and tensile failure under atmospheric load; and a protective layer on the outer surface providing resistance to environmental degradation, mechanical abrasion, and puncture from handling and installation. The specific composition of the vacuum membrane composite is a design variable governed by the required vacuum integrity, service life, flex range, and operating environment of the embodiment. [FIG. 23 illustrates a representative vacuum membrane composite cross-section for a low-to-moderate flex embodiment, showing the functional layers and their relative positions.]

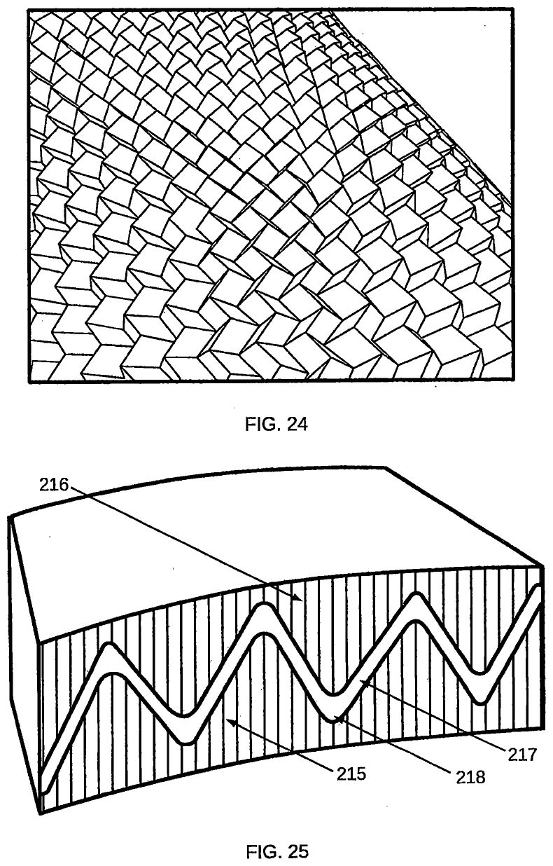

The primary challenge of the vacuum membrane in flexible embodiments is accommodating the change in surface area between the convex and concave faces of the panel as it flexes, without relying solely on the elastic properties of the membrane materials to provide the necessary overabundance of surface area on the convex side. A membrane that accommodates flexure through elastic stretching alone will develop positional memory biasing the panel toward its rest geometry and will be subject to fatigue failure at the membrane material's elastic limit under repeated flex cycles. An improved solution employs a membrane whose overabundance of surface area is organized into a designed folding geometry—such as a regular tessellated fold pattern, a Miura-fold or similar origami-derived geometry, a dimpled surface, or an irregularly gathered or crumpled configuration—so that flexure is accommodated by the controlled folding and unfolding of the membrane rather than by elastic stretching. Where discrete fold geometries such as the Miura fold are employed, the fold pattern is preferably formed into the membrane material during manufacture—for example, by casting, pressing, or otherwise shaping the membrane into its fold geometry prior to assembly—so that the membrane flexes across its pre-formed geometry, distributing stress across the formed surface rather than concentrating it at fold lines through fatigue cycling. In all such configurations, the folding geometry is supported against collapse under atmospheric pressure and against undue stress concentration at fold lines by a semi-rigid manifold underlayment, overlayment, or both, interposed between the membrane and the outermost tiers of the tensegrity framework. The manifold support layer provides sufficient rigidity to distribute atmospheric load across the fold geometry without flattening it, while remaining flexible enough to accommodate the panel's designed range of flexure without constraining it. This approach decouples the membrane's hermetic integrity from its flex accommodation function, extending service life under repeated flex cycles and eliminating the positional memory that would otherwise arise from membrane elasticity alone. [FIG. 24 and FIG. 25]

The vacuum membrane may be provided with one or more vacuum-grade valves to facilitate. evacuation, maintenance, repair, and the dynamic pressurization functions described in the following section. Valve placement and configuration are governed by the geometry of the embodiment and the requirements of the evacuation and maintenance system with which the panel is intended to be used.

### Mechanical Connection Hierarchy

The mechanical connections between the framework's structural components may be organized into four categories, referred to herein as first-degree through fourth-degree connections, each with distinct structural requirements and design considerations arising from the specific mechanical relationship of the components joined.

First-degree connections are those within a single module, joining compressive elements to intra-module tensile elements—including mid-tensile, top-tensile, and bottom-tensile elements in the column-and-spacer embodiment, and the configured tensile elements of the Escher module in the packed-core embodiment. In the column-and-spacer embodiment, the geometry of the module is fixed at first-degree connections, and the connection must maintain its attachment under the pre-tension of the tensile element and any dynamic loading encountered in use. The appropriate fastening means depends on the scale and material of the embodiment and may include tying, wrapping, crimping, bolting, adhesive bonding, or any conventional means providing sufficient grip and durability. In the Escher module, first-degree connections serve the additional function of governing the module's engagement geometry and chordal clearance as described above, and their mechanical properties—particularly the yield and deflection characteristics of the tensile elements they join—are accordingly design variables as well as structural requirements.

Second-degree connections are those within a column, at the junctions of inter-tier tensile elements with the compressive elements of adjacent modules. Tension is continuous across second-degree connections, and the connection must accommodate any range of motion arising from variable inter-tier overlap in embodiments where column height is designed to vary dynamically. In fixed-overlap embodiments, a second-degree connection may be ordinarily fastened by any means appropriate to the scale and material. In variable-overlap embodiments, where the angular trajectory of the inter-tier tensile element relative to the compressive element changes with overlap, a grooved cap, fairlead, foil guide, or equivalent guiding component may be introduced to manage this variation without damage to the tensile element or loss of positional control, as described in the column assembly section above.

Third-degree connections are those between columns, at the junctions of spacers with mid-tensile elements at positions governing inter-column spacing. Third-degree connections must satisfy three mechanical requirements simultaneously: sufficient grip to maintain the spacer's attachment position on the mid-tensile element at its governing position under lateral load; sufficient distribution of the spacer's compressive or tensile force across the mid-tensile element to avoid damage to it; and sufficient rotational freedom to accommodate the angular variation imposed on the spacer by the layer's range of flex. In simple embodiments, a clamped saddle grip may provide adequate rotational compliance through torsion propagated along the mid-tensile element from the fixed connection point. In embodiments involving large angles of flex, continuous dynamic flexing, or tensile elements that cannot accept torsion, any conventional rotational compliance mechanism—such as a bearing, pivot, or equivalent mechanical implement—may be introduced at the spacer-to-mid-tensile connection so that the spacer rotates freely around a fixed saddle, decoupling the spacer's rotational motion from the tensile element.

Fourth-degree connections are those between the tensegrity framework and the vacuum membrane or any intermediate layer. The primary concern at fourth-degree connections is preventing migration between the framework and the membrane under the compressive force of atmospheric pressure and under dynamic flex conditions. In many embodiments the pressure and friction inherent to evacuating the panel in an atmospheric environment may be sufficient to prevent such migration without additional fastening. In embodiments requiring continuous flexing or dynamically varying vacuum pressure, additional support may be provided by affixing the top-tensile elements of the uppermost tier and the bottom-tensile elements of the lowermost tier directly to the membrane—by gluing, stitching, pinning, or equivalent means—or alternatively by omitting those tensile elements altogether and fastening the ends of the compressive elements directly to the membrane using pins, eyelets, or equivalent means. Where the latter approach is taken, the membrane must provide adequate tensile strength across the fastening points, for example through embedded reinforcing strips, fibers, or equivalent tensile reinforcement, to assume the structural role of the omitted tensile elements at the layer boundary. [FIG. 13A and FIG. 13B]

### Dynamic Pressurization, Valve System, and Smart Passive Heating and Cooling

The vacuum membrane valve or valves described in the preceding section enable a range of active and passive panel management functions beyond initial evacuation, collectively referred to herein as dynamic pressurization. Dynamic pressurization exploits the ability to intentionally vary the internal pressure of the panel between vacuum and atmospheric conditions—or to any intermediate pressure—as a controllable parameter governing the panel's thermal, acoustic, and other environmentally responsive characteristics. Upon repressurization, air fills the open void volume of the tensegrity framework freely and conducts heat across the panel in a controllable and reversible manner, so that the panel's thermal behavior may be intentionally shifted between high-performance insulation at vacuum and conductive bridging at or near atmospheric pressure according to the programmatic goals of the embodiment. This dynamic range between insulating and bridging states is a designed operational mode of the present framework, enabled by the open void volume inherent to the tensegrity module geometry.

A particularly significant application of dynamic pressurization is smart passive heating and cooling: the panel's internal pressure is intentionally cycled between vacuum and atmospheric conditions in coordination with external environmental conditions, so that the panel functions as a high-performance insulator when the internal vacuum is maintained and as a conductive thermal bridge when repressurized to atmospheric pressure. This cycling behavior enables the panel to serve as a dynamically controllable thermal interface between interior and exterior environments. For example, in an architectural application, a panel integrated with an active pumping system and external temperature sensors may be depressurized during periods when exterior conditions are thermally favorable—admitting passive conductive heat transfer through the panel in either direction as desired, whether to capture solar gain stored in wall mass, to release accumulated interior heat during cool nighttime conditions, or to equalize temperatures across the envelope—and re-evacuated when exterior conditions are unfavorable, restoring full insulating performance. The transition between insulating and bridging states occurs on a timescale of minutes, governed by the pumping system's capacity relative to the panel's internal void volume, and constitutes a controllable switching operation rather than a passive material property.

More broadly, this dynamic pressurization capability reframes the panel's functional category: rather than a passive insulating material that opposes all thermal transfer equally, the panel becomes an active thermal interface that selectively couples to and decouples from the external thermal environment on an operational timescale determined by programmatic objectives. In a pressurized state, the panel permits conductive thermal transfer in either direction—admitting solar gain, releasing stored thermal mass, or equalizing temperatures as the management strategy requires. In an evacuated state, the panel blocks all conductive and convective transfer completely. This switching capability is directly relevant to net-zero building strategies, where optimal thermal performance over a diurnal cycle requires not maximum insulation at all times but selective engagement with and isolation from external thermal conditions as those conditions vary. A panel designed for repeated pressurization and depressurization cycles as part of normal operation has a defined mechanical cycle life requirement—N cycles over a service life at defined pressurization rates—which constitutes a testable, iterable engineering specification rather than an unsolved design problem, and which governs the design of the membrane, valve, and manifold underlayment systems described in the preceding sections.

In embodiments employing an active pumping system, the pump may be integrated with a control system receiving inputs from temperature sensors, pressure sensors, weather forecast data, occupancy schedules, and any other relevant environmental monitors, and programmed to execute pressurization and depressurization cycles according to a defined thermal management strategy. The control system may operate autonomously according to preset parameters, or may receive inputs from a building management system, wearable device controller, or other external system as appropriate to the embodiment. The pump and control system may be housed externally to the panel and connected via the valve, or may be integrated directly into the panel assembly in embodiments where a low-profile integrated solution is preferred. In either case, the valve interface between the pump and the panel interior must maintain hermetic integrity under repeated pressurization and depressurization cycles across the full service life of the embodiment.

### Integrated Sensors, Wireless Power Supply, Thermoelectric Generation, and Vacuum Integrity Monitoring

The performance monitoring and functional integration of a panel embodiment may be enhanced by the incorporation of one or more sensors within the hermetic envelope, together with an inductive wireless power supply that provides operating power to internal electronic components without breaching the vacuum seal. The inductive power supply comprises an external transmitter coil and an internal receiver coil, coupled across the vacuum membrane by electromagnetic induction, so that power is delivered to internal components without any wired penetration of the hermetic envelope. This approach preserves vacuum integrity while enabling continuous or on-demand operation of internal sensors and any associated microcontroller or signal processing components.

The temperature differential maintained across the panel's depth in insulating embodiments may additionally be harvested for thermoelectric power generation, by incorporating thermoelectric elements at or near the compressive element endpoints, at fourth-degree connection points between the framework and the vacuum membrane, or at any other location within the panel where a persistent temperature differential is present. The thermoelectric elements may serve any combination of functions enabled by the panel's temperature differential, including internal power generation for sensors and control components, supplementary or alternative power supply to the inductive system, export of harvested energy to external systems, and provision of a thermal flux signal for dynamic pressurization control or performance monitoring-the specific application or combination of applications being determined by the programmatic objectives of the embodiment. In embodiments employing dynamic pressurization, the variation in thermal flux across pressure states provides a correspondingly variable thermoelectric output that may serve as an additional feedback signal for the pressurization control system.

The sensor suite within the panel may include pressure and temperature sensors for vacuum integrity and thermal performance monitoring respectively, combinable as a single unit, and is not limited to these: additional sensors—including optical, radio frequency, humidity, or any other sensing modality that may be introduced within the panel volume without breaching the hermetic envelope—may be incorporated according to the programmatic objectives of the embodiment.

Sensor data may be transmitted from the internal components to external systems by any means compatible with the hermetic envelope and the operational environment of the embodiment, including radio frequency transmission, optical coupling across a transparent membrane region, inductive data coupling on the same coil assembly used for power transmission, or any other transmission modality that preserves vacuum integrity. In embodiments where the panel is integrated with a building management system, wearable device controller, active pumping system, or other external infrastructure, the wireless data link provides the feedback channel through which internal panel conditions are reported and dynamic pressurization or other active management functions are coordinated. The panel may additionally provide a universal cavity or standardized integration point for third-party sensing or communication devices, enabling modular integration of external hardware within the panel volume without custom design of the hermetic envelope for each device.

### Icosahedral Antenna Variant of the Packed-Core Module

A particularly advantageous configuration of the electromagnetic function described in paragraph [0017] and claimed in Claims 11 and 12 is achieved when the twelve endpoints of the Escher module are positioned in correspondence with the twelve vertices of an icosahedron or a geometrically related polyhedron whose vertex distribution approximates icosahedral symmetry. The icosahedron's twelve vertices are distributed in three-dimensional space with five-fold rotational symmetry about a principal axis, producing a vertex arrangement of high geometric isotropy that, when instantiated as the endpoint geometry of a tensegrity module, provides a structural antenna element with omnidirectional radiating characteristics, multi-frequency resonance arising from the multiple distinct edge lengths of the icosahedral form, and polarization diversity across all three spatial axes. The correspondence between the Escher module's twelve-endpoint structure—distributed across five planes along the diametric axis as described in paragraph [0019]—and the icosahedron's twelve vertices is achievable through selective variation of the compressive element lengths, straddle distance ratios, and pairing symmetry as described therein, tuning the endpoint geometry from the rhombic dodecahedral stellation reference toward an icosahedral vertex distribution. In embodiments configured for antenna function, the compressive elements and tensile elements are equipped with conductive surface treatments, printed traces, or conductive coatings as described in paragraph [0017], with element dimensions selected so that the resulting conductive path lengths correspond to resonant harmonics at one or more target frequencies. The three-dimensional distribution of conductive elements across all spatial axes provides radiation and reception characteristics in all directions, a property not achievable with planar or single-axis antenna configurations. Multiple icosahedral modules may be assembled in a packed arrangement in accordance with Claim 14, with adjacent modules' conductive elements forming a spatially periodic three-dimensional antenna array whose inter-module periodicity introduces additional resonant characteristics at frequencies determined by the packing geometry. [FIG. 18]

### Anomalous Nernst Effect, Three-Axis Module Geometry, and Discontinuous Thermoelectric Mesh

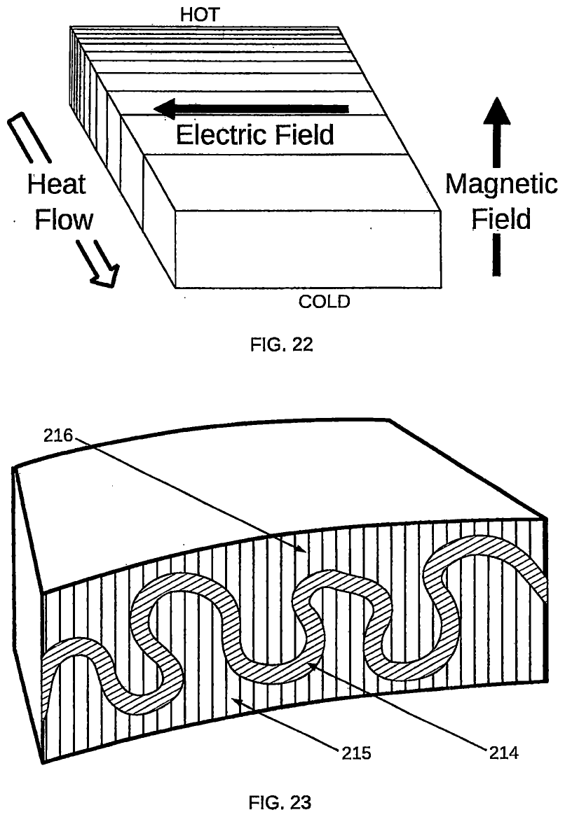

The Escher module in its orthogonal triaxial pairing configuration, as described in paragraph [0019], instantiates in physical form the three-axis vector geometry required for magneto-thermoelectric energy generation through the Anomalous Nernst Effect (ANE). The ANE is a steady-state phenomenon in ferromagnetic and spin-active materials in which a thermal gradient applied along one spatial axis generates a transverse electrical voltage along a third axis perpendicular to both the thermal gradient and the material's magnetization axis, expressed as V∝S_ANE×(M×∇T), where S_ANE is the anomalous Nernst coefficient of the material, M is the magnetization vector, and ∇T is the thermal gradient vector. The cross-product geometry M×∇T produces a voltage output on a third axis mutually perpendicular to both input quantities, a geometry that requires three independent spatial axes each occupied by a distinct physical quantity. This three-axis requirement is satisfied structurally and directly by the Escher module's three orthogonal compressive pairs, each pair occupying one of three mutually perpendicular planes sharing a common central origin. By assigning distinct material compositions to the three compressive pairs in accordance with the design variable independence described in paragraph [0019] and Claim 7, the pairs may be respectively configured as: a thermal gradient pair, whose elements are fabricated from or surface-treated with a thermoelectric or ANE-active material and are oriented along the wall-normal or primary thermal gradient axis of the assembly; a magnetization pair, whose elements are fabricated from or surface-treated with a ferromagnetic, ferrimagnetic, or spin-active material and are oriented to provide a persistent magnetization axis transverse to the thermal gradient; and a collection pair, whose elements are equipped with conductive surface traces, electrodes, or collection means oriented along the third axis perpendicular to both thermal gradient and magnetization axes, so as to harvest the ANE transverse voltage as electrical output. The cross-product relationship V∝M×∇T is not a relationship between two components of the same module pair: it is a relationship between three independently assigned material axes, each corresponding to one compressive pair, and the resulting voltage output is available at the collection pair elements as a continuous DC electrical signal proportional to the product of the magnetization magnitude and the thermal gradient magnitude at the module's location. [FIG. 22 illustrates the three-axis geometry of the Anomalous Nernst Effect as described above.]

When a plurality of modules configured in this manner are assembled in a packed arrangement in accordance with the packed-core embodiment of Claims 2 and 14, with all modules sharing a common global orientation of their thermal gradient, magnetization, and collection axes, the aggregate functions as a discontinuous thermoelectric mesh: a spatially distributed, modular network of individual ANE-generating units whose outputs are electrically connected through inter-module conductive paths, conductive traces applied to the aggregate surface, or supplementary wiring integrated during assembly, in series, parallel, or series-parallel configurations as required by the power and voltage specifications of the target load. The discontinuous character of the mesh—arising from the discrete module structure of the packed aggregate, in which each module is a self-contained generating unit separated from its neighbors by inter-module contact geometry rather than continuous solid medium—provides fault tolerance absent from continuous thermoelectric devices: localized module failure does not propagate through the mesh, and the electrical output of the surviving modules is degraded proportionally rather than lost entirely. The total electrical output of the mesh scales with the number of modules in the aggregate, and accordingly with the volume of the packed core, providing a power output that increases with the insulating thickness of the assembly—a property that makes the discontinuous thermoelectric mesh architecture particularly well suited to thick-wall cryogenic storage vessels and architectural insulating assemblies, in which greater insulating volume simultaneously increases thermal performance and thermoelectric generating capacity.

A particularly significant variant of the magnetization pair assignment employs a material whose magnetic permeability, coercivity, saturation magnetization, or spin-ordering parameter varies as a monotonic function of temperature within the operating temperature range of the assembly.

When such a material is used for the magnetization pair, the thermal gradient maintained across the assembly produces a spatial gradient in the magnetic character of the magnetization pair along its length, with the cold-side region exhibiting different magnetic ordering than the warm-side region. This differential in magnetic character constitutes an intrinsic, self-sustaining magnetization asymmetry that provides the symmetry-breaking condition required for ANE generation without any externally applied magnetizing field or current. The assembly is accordingly self-magnetizing under operating conditions: the thermal gradient that drives thermoelectric output simultaneously sustains the magnetic asymmetry that enables it, through the intrinsic magneto-thermal response of the selected magnetization pair material. Materials suitable for this self-magnetizing function include magnetocaloric alloys, ferromagnetic transition-metal compounds, and rare-earth-containing intermetallic compounds whose Curie temperatures, magnetocaloric coefficients, or spin-ordering parameters place their magneto-thermal response within the operating temperature range of the specific embodiment.

The low absolute temperature of the cryogenic cold reservoir provides a Carnot efficiency ceiling substantially higher than is achievable with thermoelectric systems operating between ambient and elevated temperatures at equivalent temperature differentials, yielding a correspondingly greater extractable fraction of the traversing heat flux. A further consequence specific to the cryogenic vessel application is that the heat flux traversing the insulating annulus is parasitic ingress that would otherwise be expended entirely in evaporating the cryogenic liquid; the thermoelectric generating elements accordingly intercept a fraction of this unavoidable loss and convert it to useful electrical work before it reaches the inner vessel surface, simultaneously reducing boil-off and powering the internal sensor suite from a single thermodynamic input requiring no additional energy supply.

### Cryogenic and Hermetic Vessel Integration, In-Vessel Self-Powered Sensor Systems, and Responsive Calibration

The thermoelectric generating architecture described in paragraph [0027] is particularly advantageous for application to cryogenic storage vessels in which a large, persistent temperature differential exists between an inner vessel surface maintained at cryogenic temperature and an outer vessel surface at ambient temperature. The insulating annulus between the inner and outer surfaces may be occupied by a packed aggregate of ANE-configured Escher modules in accordance with the packed-core embodiment, providing structural resistance to compressive load while generating electrical power from the thermal differential across the annulus without any wired penetration of the vessel wall.

The generated power may be applied to an internal sensor suite comprising one or more of: a liquid level sensor; a vapor-phase temperature sensor; an internal pressure sensor; a vacuum jacket integrity sensor; a gas purity sensor; a tilt and vibration sensor; and a location sensor. The sensor suite operates continuously and autonomously without external wiring, battery, or mains connection.

Sensor data is transmitted to external monitoring systems by wireless means compatible with the hermetic envelope. The thermoelectric output signal—being proportional to the thermal flux across the annulus—additionally serves as an independent continuous measure of insulating performance, enabling correlation with internal sensor readings to detect vacuum degradation, anomalous heat ingress, and sensor drift without external instrumentation. A microcontroller within the hermetic envelope, powered by the thermoelectric mesh, may execute this calibration continuously and transmit calibrated readings and diagnostic flags to external systems. The heat flux traversing the insulating annulus is parasitic ingress that would otherwise evaporate the cryogenic liquid; the thermoelectric elements intercept a fraction of this unavoidable loss and convert it to useful electrical work, simultaneously reducing boil-off and powering the internal sensor suite from a single thermodynamic input requiring no additional energy supply. In embodiments subject to repeated fill and drain cycles, the thermoelectric output profile during each fill cycle provides a diagnostic signature whose deviation from a baseline indicates changes in vessel condition, enabling condition-based maintenance scheduling without external instrumentation.

1. A mechanical tensegrity framework comprising:
a plurality of discrete self-equilibrating modules, each module comprising a plurality of compressive elements held in a stable spatial arrangement solely by intra-module tensile elements connected between attachment points on the compressive elements, without direct contact between any two compressive elements within the module, such that each module maintains its own internal compressive-tensile equilibrium independently of any enclosing wall, membrane, or neighboring module;
a plurality of columns, each column comprising a linear series of said modules connected end-to-end by inter-tier tensile elements external to each individual module, wherein the compressive elements of adjacent modules within a column physically interpenetrate without direct contact, the interpenetrating arrangement being maintained exclusively by the inter-tier tensile elements; and
a plurality of spacers extending laterally between adjacent columns and connecting mechanically to reciprocal mid-tensile elements within those columns at positions governing inter-column spacing and enabling controlled flexure of the framework.

2. A mechanical tensegrity framework comprising:
a plurality of discrete self-equilibrating modules, each module comprising six compressive elements arranged as three pairs, each pair consisting of two members oriented in parallel or near-parallel relationship and straddling a shared central origin by a characteristic offset distance, the three pairs disposed in mutually non-coplanar orientations at angles to one another that may be orthogonal, non-orthogonal, or mixed, with the twelve endpoints of the six compressive elements distributed in three-dimensional space, the compressive elements of each module held in their spatial arrangement by intra-module tensile elements connected among attachment points defined by the twelve endpoints, without direct contact between any two compressive elements within the module, such that each module maintains its own internal compressive-tensile equilibrium independently of any enclosing structure;
wherein a plurality of said modules are assembled in a packed arrangement without fixed inter-module connections, such that under compressive loading the aggregate maintains tensegrity conditions at the system level, with compressive loads transmitted discontinuously through the compressive elements of individual modules and tensile forces distributed through inter-module contact at surfaces whose geometry is governed by the tensile chord envelope of the individual modules; and
wherein the tensile chord geometry of the intra-module tensile elements, governed by the rank and position of the connections employed among the twelve attachment points, constitutes a primary design variable governing the chordal clearance between neighboring module origins and the geometric specificity of inter-module contact relationships in the packed aggregate.

3. The framework of claim 1, wherein the framework is configurable between a collapsed state in which adjacent modules within a column are nested with their compressive elements in contact and an active state in which the interpenetrating non-contacting geometry is established, the transition between states being governed by the elastic properties and yield characteristics of the inter-tier tensile elements, by mechanical stops integrated into the spacer system, by mechanical or electromechanical tensioning mechanisms that dynamically adjust inter-tier tensile element length, or by external actuation.

4. The framework of claim 1, wherein controlled flexure is achieved by designating at least one fulcrum tier populated with spacers of fixed length establishing a fixed lateral reference plane, and one or more peripheral tiers populated with spacers having a defined range of operative length proportionate to their distance from the fulcrum tier, such that the framework may curve in three dimensions about the fulcrum plane.

5. The framework of claim 1, wherein the framework comprises a plurality of layers fractally compounded across at least two scales, each layer having module span, module height, and inter-column span scaled in approximate proportion relative to at least one adjacent layer by a chosen ratio, the scaling ratio and lateral positioning of adjacent layers selected so that the endpoints of compressive elements in one layer align with or are supportable by the central axes of corresponding columns in the adjacent scaled layer, producing a hierarchical load-transfer relationship between layers that reinforces structural integrity across scales, wherein the fractal compounding may be reiterated across additional layers in either direction of scale and the scaling ratio need not be uniform between successive layers.

6. The framework of claim 2, wherein the twelve endpoints of each module are collectively positioned in correspondence with the stellated points of the first stellation of the rhombic dodecahedron or of a variant form thereof, the endpoints being distributed across five parallel planes orthogonal to a diametric axis, designated proceeding from one diametric endpoint to the other as the base plane, near plane, mid plane, far plane, and diametric plane, containing one, four, two, four, and one endpoints respectively, wherein the three compressive pairs are configured in an orthogonal triaxial pairing with each pair's endpoints drawn between parallel sets of mid-rank connections between the base plane and mid plane, or in a non-orthogonal triaxial pairing with each pair's endpoints drawn between parallel sets of far-rank connections between the base plane and far plane, or in a mixed pairing in which compressive pairs employ connections of different ranks across the three pairs, and wherein the space-filling packing geometry of the first stellation of the rhombic dodecahedron produces an interlocking aggregate in which each module's stellated endpoints nest into the recesses between neighboring modules' endpoints.

7. The framework of claim 2, wherein one or more of the primary design variables—the length of the compressive elements, the ratio of straddle distance to compressive element length for each pair, the number and pattern of intra-module tensile elements, the yield characteristics of those tensile elements, and the rigidity and deflection characteristics of the compressive elements under load—are varied independently across the three compressive pairs to produce directionally differentiated internal clearance at crossing lines, chordal clearance, engagement geometry, or mechanical response in the packed aggregate.

8. The framework of claim 2, wherein a tensile routing component is introduced, fastened at or wrapped around defined intermediate points along existing intra-module tensile elements, or fastened between such intermediate points and one or more of the module's twelve attachment points, the tensile routing component deflecting selected intra-module tensile elements at various angles away from their chordal paths, and optionally incorporating friction-reducing coupling guides at deflection points to manage angular variation without damage to the tensile elements, the offset being uniform across all planes of the module or varied independently across planes to produce regular, irregular, or asymmetric engagement geometry and corresponding chordal clearance profile.

9. The framework of claim 2, wherein the compressive elements of each module are joined into a single multi-branched rigid unit comprising three mutually oriented rectangles sharing a common center, with one set of opposing edges for each rectangle corresponding to the compressive element pair of that plane, and wherein tensile elements connect the endpoints of the rigid form without providing internal tensegrity equilibrium, tensegrity conditions emerging at the system level from inter-module contact at abutting tensile element spans.

10. The framework of claim 9, wherein the outer surfaces of the rigid unit are treated with a reflective surface treatment comprising a low-emissivity material including metallic foils, aluminized films, vapor-deposited metallic layers, or equivalent multi-layer insulation materials, to produce a distributed reflective scattering effect across the packed aggregate.

11. The framework of claim 1, wherein one or more layers are configured for electromagnetic function by one or more of: selecting compressive element dimensions, inter-element spacing, and angular orientation relative to the layer surface to produce geometric periodicities corresponding to harmonic resonances at target electromagnetic frequencies including radio, microwave, or higher electromagnetic frequencies at fundamental frequencies, fractional harmonics, or integer multiples thereof; specifying conductive materials for compressive or tensile elements; applying conductive surface treatments to compressive or tensile elements selected from printed traces, coiled conductors, conductive coatings, and other conductive surface modifications; systematically varying material composition across elements sharing a particular angle of incidence to produce spatially anisotropic electromagnetic responses including amplification, attenuation, shaping, plasmonic coupling, or focusing of electromagnetic energy; and configuring hierarchically scaled layers in which the scaling ratio between adjacent layers produces resonant periodicities spanning multiple frequency decades.

12. The framework of claim 2, wherein one or more module arrangements are configured for electromagnetic function by one or more of: selecting compressive element dimensions, inter-element spacing, and angular orientation relative to the aggregate surface to produce geometric periodicities corresponding to harmonic resonances at target electromagnetic frequencies including radio, microwave, or higher electromagnetic frequencies at fundamental frequencies, fractional harmonics, or integer multiples thereof; specifying conductive materials for compressive or tensile elements; applying conductive surface treatments to compressive or tensile elements selected from printed traces, coiled conductors, conductive coatings, and other conductive surface modifications; systematically varying material composition across elements sharing a particular angle of incidence to produce spatially anisotropic electromagnetic responses including amplification, attenuation, shaping, plasmonic coupling, or focusing of electromagnetic energy; and configuring hierarchically scaled module arrangements in which the scaling ratio between adjacent scales produces resonant periodicities spanning multiple frequency decades.

13. The framework of claim 1, further comprising a hermetic envelope enclosing the framework and evacuated to form a vacuum-insulated panel, the hermetic envelope comprising a composite vacuum membrane having at least a gas-impermeable layer and a structural layer providing resistance to puncture and atmospheric compressive load.

14. The framework of claim 2, further comprising a hermetic envelope enclosing the packed arrangement and evacuated to form a vacuum-insulated panel, the hermetic envelope and any intermediate protective layers transmitting atmospheric compressive load to the module aggregate without concentrating stress at individual module contact points to a degree causing compressive element failure.

15. The framework of claim 13, wherein the internal pressure of the panel is intentionally varied between vacuum and atmospheric conditions or any intermediate pressure as a controllable parameter governing the panel's thermal or other environmentally responsive characteristics.

16. The framework of claim 14, wherein the internal pressure of the panel is intentionally varied between vacuum and atmospheric conditions or any intermediate pressure as a controllable parameter governing the panel's thermal or other environmentally responsive characteristics.

17. The framework of claim 13, further comprising an inductive wireless power supply comprising an external transmitter coil and an internal receiver coil coupled across the vacuum membrane by electromagnetic induction, and one or more internal sensors selected from pressure sensors, temperature sensors, and combinations thereof, the sensors providing monitoring of vacuum integrity and thermal performance without breach of the hermetic envelope, with sensor data transmitted to external systems by wireless means compatible with the hermetic envelope.

18. The framework of claim 14, further comprising an inductive wireless power supply comprising an external transmitter coil and an internal receiver coil coupled across the vacuum membrane by electromagnetic induction, and one or more internal sensors selected from pressure sensors, temperature sensors, and combinations thereof, the sensors providing monitoring of vacuum integrity and thermal performance without breach of the hermetic envelope, with sensor data transmitted to external systems by wireless means compatible with the hermetic envelope.

19. The framework of claim 13, further comprising thermoelectric elements positioned at locations within the panel where a persistent temperature differential is present, the thermoelectric elements configured to perform one or more of: generating electrical power from the temperature differential for supply to internal electronic components; supplementing or replacing an inductive wireless power supply within the panel where such a supply is also present; exporting harvested energy to external systems; and providing a thermal flux signal for dynamic pressurization control or performance monitoring.

20. The framework of claim 14, further comprising thermoelectric elements positioned at locations within the panel where a persistent temperature differential is present, the thermoelectric elements configured to perform one or more of: generating electrical power from the temperature differential for supply to internal electronic components; supplementing or replacing an inductive wireless power supply within the panel where such a supply is also present; exporting harvested energy to external systems; and providing a thermal flux signal for dynamic pressurization control or performance monitoring.

21. The framework of claim 13, wherein the vacuum membrane further comprises a manifold underlayment, overlayment, or both, supporting a designed overabundance of membrane surface area organized into a pre-formed geometry selected from tessellated fold patterns, Miura-fold or other origami-derived geometries, dimpled surfaces, irregularly gathered configurations, and combinations thereof, the geometry being pre-formed into the membrane material during manufacture such that flexure is accommodated by folding and unfolding across the pre-formed geometry rather than by elastic stretching of the membrane material, distributing flex stress across the formed surface and extending service life under repeated flex cycles.

22. The framework of claim 14, wherein the vacuum membrane further comprises a manifold underlayment, overlayment, or both, supporting a designed overabundance of membrane surface area organized into a pre-formed geometry selected from tessellated fold patterns, Miura-fold or other origami-derived geometries, dimpled surfaces, irregularly gathered configurations, and combinations thereof, the geometry being pre-formed into the membrane material during manufacture such that flexure is accommodated by folding and unfolding across the pre-formed geometry rather than by elastic stretching of the membrane material, distributing flex stress across the formed surface and extending service life under repeated flex cycles.

23. A method of managing the environmental performance of a vacuum-insulated panel, the panel comprising a tensegrity framework core of discrete self-equilibrating modules in which compressive elements within each module are held in stable spatial arrangement by tensile elements without direct contact between any two compressive elements, the modules assembled into an open-structure core enclosed within a hermetic envelope, the open-structure geometry of the core providing an evacuable void volume, the method comprising:
evacuating the hermetic envelope to a target vacuum pressure to establish a high-performance insulating state in which conductive and convective heat transfer through the panel is substantially eliminated;
selectively repressurizing the hermetic envelope to atmospheric pressure or an intermediate pressure according to a defined operational protocol to establish a conductive bridging state in which the open void volume of the tensegrity framework core is occupied by a gas medium enabling conductive thermal transfer through the panel; and re-evacuating the hermetic envelope to restore the insulating state;
wherein the intentional variation of internal pressure between the insulating state and the conductive bridging state constitutes a controllable environmental management parameter whose operational range is made possible by the open void volume inherent to the tensegrity framework core geometry.

24. The framework of claim 15, wherein the dynamic pressurization is coordinated with external environmental conditions by a control system that selectively establishes a vacuum insulating state when thermal transfer between the panel's interior and exterior environments is programmatically undesirable, and selectively establishes a pressurized conductive bridging state when thermal transfer is programmatically desirable, the control system receiving inputs from one or more environmental sensors and executing pressurization and depressurization cycles on an operational timescale according to a defined thermal management strategy.

25. The framework of claim 16, wherein the dynamic pressurization is coordinated with external environmental conditions by a control system that selectively establishes a vacuum insulating state when thermal transfer between the panel's interior and exterior environments is programmatically undesirable, and selectively establishes a pressurized conductive bridging state when thermal transfer is programmatically desirable, the control system receiving inputs from one or more environmental sensors and executing pressurization and depressurization cycles on an operational timescale according to a defined thermal management strategy.

26. (canceled)

27. (canceled)

28. A magneto-thermoelectric energy harvesting assembly comprising:
a structural framework comprising a plurality of discrete modules, each module comprising a plurality of compressive elements arranged as at least three pairs disposed in mutually non-coplanar orientations about a shared central origin, the compressive elements of each module held in stable spatial arrangement by intra-module tensile elements without direct contact between any two compressive elements within the module;
wherein a first pair of compressive elements, designated the thermal gradient pair, is fabricated from or surface-treated with a material exhibiting a non-zero Anomalous Nernst coefficient, the thermal gradient pair oriented along a primary thermal gradient axis extending between a cold boundary and a warm boundary of the assembly;
wherein a second pair of compressive elements, designated the magnetization pair, is fabricated from or surface-treated with a ferromagnetic, ferrimagnetic, or spin-active material exhibiting persistent or thermally induced magnetic ordering within the operating temperature range of the assembly, the magnetization pair oriented to provide a magnetization axis substantially perpendicular to the thermal gradient axis;
wherein a third pair of compressive elements, designated the collection pair, is equipped with conductive surface traces, electrodes, or collection elements connected to an electrical output circuit, the collection pair oriented along a third axis substantially perpendicular to both the thermal gradient axis and the magnetization axis;
such that a thermal gradient maintained between the cold boundary and the warm boundary produces, through the Anomalous Nernst Effect, a transverse electrical voltage at the collection pair proportional to the vector cross-product of the magnetization vector of the magnetization pair and the thermal gradient vector, the transverse voltage being available as electrical power output at the collection pair without any wired thermal bridge spanning the full thermal gradient of the assembly.

29. The assembly of claim 28, wherein the ferromagnetic, ferrimagnetic, or spin-active material of the magnetization pair exhibits a magnetic permeability, coercivity, saturation magnetization, or spin-ordering parameter that varies as a monotonic function of temperature within the operating temperature range of the assembly, such that the thermal gradient maintained across the assembly produces a spatial gradient in the magnetic character of the magnetization pair between the cold boundary and the warm boundary, the gradient in magnetic character constituting an intrinsic magnetization asymmetry that provides the symmetry-breaking condition required for Anomalous Nernst Effect generation without the application of any externally imposed magnetizing field, the assembly thereby being self-magnetizing under operating conditions through the intrinsic magneto-thermal response of the magnetization pair material.

30. The assembly of claim 28, wherein a plurality of said modules are assembled in a packed arrangement in accordance with the packed-core framework of claim 2, all modules sharing a common global orientation such that the thermal gradient axis, magnetization axis, and collection axis of each module are mutually aligned across the aggregate, and wherein the collection pair elements of individual modules are electrically interconnected through inter-module conductive paths, surface-applied conductive traces, or supplementary wiring in series, parallel, or series-parallel configurations to form a discontinuous thermoelectric mesh in which each module constitutes a discrete generating unit, the aggregate electrical output of the mesh scaling with the number of modules in the packed arrangement, the mesh exhibiting fault tolerance such that localized failure of individual modules degrades aggregate output proportionally without propagating failure to neighboring modules.

31. A cryogenic storage vessel comprising:
an inner vessel surface maintained at cryogenic operating temperature and an outer vessel surface maintained at or near ambient temperature, defining a persistent thermal differential between the inner and outer surfaces;
an insulating annulus between the inner and outer vessel surfaces, the annulus occupied at least in part by a packed aggregate of discrete tensegrity modules in accordance with Claim 2, the modules providing structural resistance to compressive load while maintaining an open void volume within the annulus;
a plurality of thermoelectric generating elements positioned within the insulating annulus and thermally coupled to span at least a portion of the thermal differential between the inner and outer vessel surfaces, the thermoelectric generating elements producing electrical power from the thermal differential without any electrically conductive wired pathway penetrating the hermetic boundary of the vessel;
one or more internal sensors positioned within the hermetic boundary of the vessel and electrically connected to receive operating power from the thermoelectric generating elements, the internal sensors selected from the group consisting of liquid level sensors, vapor-phase temperature sensors, internal pressure sensors, vacuum jacket integrity sensors, gas purity sensors, tilt and vibration sensors, location sensors, and combinations thereof; and
a wireless data transmission element positioned within the hermetic boundary and powered by the thermoelectric generating elements, configured to transmit sensor data to external monitoring systems without wired penetration of the hermetic boundary.

32. The cryogenic storage vessel of claim 31, further comprising a microcontroller or signal processing element positioned within the hermetic boundary and powered by the thermoelectric generating elements, the microcontroller configured to execute a responsive calibration process comprising: receiving the electrical output signal of the thermoelectric generating elements as a continuous measure of thermal flux across the insulating annulus;
correlating the thermal flux signal with readings from the internal sensors to produce a continuously updated thermal model of the vessel; identifying deviations of the thermal flux signal or sensor readings from baseline values indicative of vacuum degradation, anomalous heat ingress, sensor drift, or changes in vessel condition; and transmitting calibrated sensor readings and diagnostic flags to external monitoring systems via the wireless data transmission element, such that the vessel provides self-calibrating condition monitoring whose diagnostic accuracy improves with operating time as the thermal model is refined against accumulated operating data.

33. A method of monitoring the condition of a hermetically sealed vessel containing a cryogenic or otherwise temperature-controlled medium, the vessel having an inner surface maintained at a first temperature and an outer surface maintained at a second temperature greater than the first temperature, the method comprising:
generating electrical power within the hermetic boundary of the vessel by positioning thermoelectric generating elements to span at least a portion of the thermal differential between the inner and outer surfaces, the thermoelectric generating elements producing electrical power from the thermal differential as a continuous autonomous power source without external wiring penetrating the hermetic boundary;
powering one or more internal sensors from the generated electrical power, the internal sensors monitoring one or more of liquid level, vapor-phase temperature, internal pressure, vacuum jacket integrity, gas purity, tilt, vibration, and location;
correlating the electrical output of the thermoelectric generating elements with the readings of the internal sensors to produce a thermal flux signal serving as an independent continuous measure of insulating performance of the vessel;
detecting deviations of the thermal flux signal or sensor readings from baseline values to identify changes in vessel condition; and
transmitting sensor data and condition assessments to external monitoring systems by wireless means without wired penetration of the hermetic boundary;
wherein the steps of generating, powering, correlating, detecting, and transmitting are executed continuously and autonomously without external power supply or battery, the method being self-sustaining for as long as the thermal differential between the inner and outer surfaces is maintained.
